(19) United States
(12) Patent Application Publication
(10) Pub. No.: US 2020/0140085 A1
(43) Pub. Date: May 7, 2020

(54) PORTABLE INTEGRATED UAV

(71) Applicant: SZ DJI TECHNOLOGY CO., LTD., Shenzhen (CN)

(72) Inventors: Yumian DENG, Shenzhen (CN); Tao ZHAO, Shenzhen (CN)

(21) Appl. No.: 16/719,050

(22) Filed: Dec. 18, 2019

Related U.S. Application Data
(63) Continuation of application No. PCT/CN2017/091832, filed on Jul. 5, 2017.

(51) Int. Cl. B64C 39/02; B64D 47/08

(52) U.S. Cl. CPC B64C 39/024; B64D 47/08; B64C 2201/182; B64C 2201/108; B64C 2201/127; B64C 2201/027

(57) ABSTRACT

An unmanned aerial vehicle (UAV) includes a central body having a lateral dimension substantially less than a vertical dimension, and one or more propulsion units supported by the central body. The one or more propulsion units include rotor blades configured to rotate to generate lift for the UAV.

### CROSS-REFERENCE TO RELATED APPLICATION

This application is a continuation of International Application No. PCT/CN2017/091832, filed Jul. 5, 2017, the entire content of which is incorporated herein by reference.

### BACKGROUND OF THE DISCLOSURE

Unmanned aerial vehicles (UAVs) are used for aerial photography. Oftentimes, UAVs have a quadcopter format, with four motors and sets of rotor blades. The volume for quadcopter UAVs are often fairly large to support the motors. When quadcopter sizes are reduced, this may be at the expense of force efficiency, which quickly drains the battery and does not permit extended flight.

Furthermore, when flying in the air, traditional quadcopters may make the body lean forward, generating a reversal of an airfoil and thereby causing wind pressure downwards. This causes increased drag, which requires more force from the motors to counteract the drag. This reduces battery life.

### SUMMARY OF THE DISCLOSURE

A need exists for unmanned aerial vehicles (UAVs) that are both portable and that provide stable flight. A further need exists for UAVs that reduce drag, and provide extended battery life, thereby permitting longer flights on a given battery charge. Moreover, a need exists for UAVs that are suited for aerial and manual photography, such as selfies.

Systems and methods for improved flight of portable UAVs are provided. A UAV may be configured to have a central body with a lateral dimension substantially less than a vertical dimension, and one or more propulsion units may be provided. In some instances, two propulsion units may be supported at distal ends of a narrow central body. The UAV may have a small footprint and reduced wind resistance. In some embodiments, components may be added or moved around the portable UAV for increased functionality. The UAV may be used for aerial and land-based photography.

Aspects of the disclosure are directed to an unmanned aerial vehicle (UAV) comprising: a central body having a lateral dimension substantially less than a vertical dimension; and one or more propulsion units supported by the central body, wherein the one or more propulsion units comprise rotor blades configured to rotate to generate lift for the UAV.

Furthermore, aspects of the disclosure may be directed to a method for providing an unmanned aerial vehicle (UAV), said method comprising: providing a central body having a lateral dimension substantially less than a vertical dimension; and supporting, by the central body, one or more propulsion units, wherein the one or more propulsion units comprise rotor blades configured to rotate to generate lift for the UAV.

Additional aspects of the disclosure may be directed to a kit for an unmanned aerial vehicle (UAV) comprising: a central body having a lateral dimension substantially less than a vertical dimension; one or more propulsion units configured to be supported by the central body, wherein the one or more propulsion units comprise rotor blades configured to rotate to generate lift for the UAV; and instructions for assembly or operation of the UAV.

Aspects of the disclosure may also include an unmanned aerial vehicle (UAV) comprising: a central body having a longitudinal axis extending along a length of the central body, wherein the length is greater than or equal to a width of the central body; and at least two propulsion units supported at distal ends of the central body along the longitudinal axis, wherein the propulsion units comprise rotor blades configured to rotate to generate lift for the UAV.

A method for providing an unmanned aerial vehicle (UAV) may be provided in accordance with further aspects of the disclosure. The method may comprise: providing a central body having a longitudinal axis extending along a length of the central body, wherein the length is greater than or equal to a width of the central body; and supporting, at distal ends of the central body, at least two propulsion units along the longitudinal axis, wherein the propulsion units comprise rotor blades configured to rotate to generate lift for the UAV.

Moreover, aspects of the disclosure may be directed to a kit for an unmanned aerial vehicle (UAV) comprising: a central body having a longitudinal axis extending along a length of the central body, wherein the length is greater than or equal to a width of the central body; at least two propulsion units configured to be supported at distal ends of the central body along the longitudinal axis, wherein the propulsion units comprise rotor blades configured to rotate to generate lift for the UAV; and instructions for assembly or operation of the UAV.

In accordance with additional aspects of the disclosure, an unmanned aerial vehicle (UAV) may comprise: a central body; and one or more propulsion units supported by the central body, wherein the one or more propulsion units comprise rotor blades configured to rotate to generate lift for the UAV; and an image capturing device, wherein the rotor blades are located above the image-capturing device during a first flight mode, and the rotor blades are located beneath the image capturing device during a second flight mode, wherein a transition between the first flight mode and the second flight mode is effected by adjusting an orientation of the one or more propulsion units relative to the central body.

Aspects of the disclosure may be directed to a method for providing an unmanned aerial vehicle (UAV), said method comprising: providing a central body; supporting, by the central body, one or more propulsion units, wherein the one or more propulsion units comprise rotor blades configured to rotate to generate lift for the UAV; and providing an image capturing device, wherein the rotor blades are located above the image-capturing device during a first flight mode, and the rotor blades are located beneath the image capturing device during a second flight mode, wherein a transition between the first flight mode and the second flight mode is effected by adjusting an orientation of the one or more propulsion units relative to the central body.

Further aspects of the disclosure may be directed to a kit for an unmanned aerial vehicle (UAV) comprising: a central body; one or more propulsion units configured to be supported by the central body, wherein the one or more propulsion units comprise rotor blades configured to rotate to generate lift for the UAV; an image capturing device, wherein the rotor blades configured to be located above the image-capturing device during a first flight mode, and the rotor blades configured to be located beneath the image capturing device during a second flight mode, wherein a transition between the first flight mode and the second flight mode is effected by adjusting an orientation of the one or more propulsion units relative to the central body; and instructions for assembly or operation of the UAV.

Additionally, aspects of the disclosure may provide an unmanned aerial vehicle (UAV) comprising: a central body; one or more propulsion units supported by the central body, wherein the one or more propulsion units comprise rotor blades configured to rotate to generate lift for the UAV; and an extension that can be attached and detached from multiple portions of the central body.

A method for providing an unmanned aerial vehicle (UAV) may be provided in accordance with aspects of the disclosure, said method comprising: providing a central body; and supporting, by the central body, one or more propulsion units along the longitudinal axis, wherein the one or more propulsion units comprise rotor blades configured to rotate to generate lift for the UAV; and providing an extension that can be attached and detached from multiple portions of the central body.

Moreover, aspects of the disclosure may be directed to a kit for an unmanned aerial vehicle (UAV) comprising: a central body; one or more propulsion units configured to be supported by the central body, wherein the one or more propulsion units comprise rotor blades configured to rotate to generate lift for the UAV; an extension that can be attached and detached from multiple portions of the central body; and instructions for assembly or operation of the UAV.

In accordance with further aspects of the disclosure, an unmanned aerial vehicle (UAV) may comprise: a central body having a longitudinal axis extending along a length of the central body; one or more propulsion units, wherein the propulsion units comprise rotor blades configured to rotate to generate lift for the UAV; and one or more airfoils configured to detachably coupled to the central body along the longitudinal axis.

Aspects of the disclosure may also be directed to a method for providing an unmanned aerial vehicle (UAV), said method comprising: providing a central body having a longitudinal axis extending along a length of the central body; supporting, by the central body, one or more propulsion units, wherein the one or more propulsion units comprise rotor blades configured to rotate to generate lift for the UAV; and providing one or more airfoils configured to detachably coupled to the central body along the longitudinal axis.

Furthermore, aspects of the disclosure may be directed to a kit for an unmanned aerial vehicle (UAV) comprising: a central body having a longitudinal axis extending along a length of the central body; one or more propulsion units, wherein the propulsion units comprise rotor blades configured to rotate to generate lift for the UAV; one or more airfoils configured to detachably coupled to the central body along the longitudinal axis; and instructions for assembly or operation of the UAV.

Additional aspects of the disclosure may be directed to an unmanned aerial vehicle (UAV) comprising: a central body; one or more propulsion units directly supported by the central body, wherein the propulsion units comprise rotor blades configured to rotate to generate lift for the UAV; and one or more arms configured to detachably coupled to the central body, wherein each of the one or more arms is configured to support one or more additional propulsion units.

In accordance with further aspects of the disclosure, a method for providing an unmanned aerial vehicle (UAV) may be provided. The method may comprise: providing a central body; supporting, by the central body, one or more propulsion units, wherein the one or more propulsion units comprise rotor blades configured to rotate to generate lift for the UAV; and providing one or more arms configured to detachably coupled to the central body, wherein each of the one or more arms is configured to support one or more additional propulsion units.

Aspects of the disclosure may be directed to a kit for an unmanned aerial vehicle (UAV) comprising: a central body; one or more propulsion units directly supported by the central body, wherein the propulsion units comprise rotor blades configured to rotate to generate lift for the UAV; one or more arms configured to detachably coupled to the central body, wherein each of the one or more arms is configured to support one or more additional propulsion units; and instructions for assembly or operation of the UAV.

Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present disclosure will be obtained by reference to the following detailed description that sets forth illustrative embodiments, in which the principles of the disclosure are utilized, and the accompanying drawings (also “Figure” and “FIG.” herein), of which:

FIG. 1 shows an example of an unmanned aerial vehicle (UAV), in accordance with embodiments of the disclosure.

FIG. 2 shows an example of a UAV with a possible internal layout, in accordance with embodiments of the disclosure.

FIG. 3 shows examples of wind effects on UAVs, in accordance with embodiments of the disclosure.

FIG. 4 shows an example of a UAV with airfoil attachments, in accordance with embodiments of the disclosure.

FIG. 5 shows an example of a UAV with foldable propellers, in accordance with embodiments of the disclosure.

FIG. 6 shows an example of a UAV with multiple mounting sites, and an extension that can be attached or detached from the multiple mounting sites, in accordance with embodiments of the disclosure.

FIG. 7 shows an example of how an extension can be attached to a UAV as protective gear, in accordance with embodiments of the disclosure.

FIG. 8 shows an example of how an extension can be attached to a UAV as a landing stand, in accordance with embodiments of the disclosure.

FIG. 9 shows an example of a foldable landing stand, in accordance with embodiments of the disclosure.

FIG. 10 shows an example of an extension that can be attached to the UAV as a tripod, in accordance with embodiments of the disclosure.

FIG. 11 shows an example of an extension that can be attached to the UAV as a selfie stick, in accordance with embodiments of the disclosure.

FIG. 12 shows multiple ways in which the UAV can be held, in accordance with embodiments of the disclosure.

FIG. 13 shows a handheld sling and phone holder, in accordance with embodiments of the disclosure.

FIG. 14 shows an example of a UAV in a reverse flying mode, in accordance with embodiments of the disclosure.

FIG. 15 shows an example of a UAV with one or more arm extensions supporting additional propellers, in accordance with embodiments of the disclosure.

FIG. 16 is a schematic diagram of an example of a movable object including a carrier and a payload, in accordance with embodiments of the disclosure.

FIG. 17 is a schematic diagram of an example of a system for controlling a movable object, in accordance with embodiments of the disclosure.

### DETAILED DESCRIPTION OF THE EMBODIMENTS

Systems, methods, and devices are provided for providing portable unmanned aerial vehicles (UAVs). A UAV may traverse an environment with aid of one or more propulsion units, such as propellers. The UAV may have a compact central body. The central body may have a significantly smaller lateral dimension than a vertical dimension. In some embodiments, the central body may have a significantly smaller width than length. The propellers may be supported directly on the central body. In some embodiments, two propellers may be supported at distal ends of the central body along a longitudinal axis of the central body.

The UAV may be configured to have reduced wind resistance. The narrow central body of the UAV may provide a reduced lateral footprint that can experience the downwards airflow from the propellers. This may require less energy input to the motors to maintain flight, and provide an extended battery life. During flight, the UAV may be capable of maneuvering to use the central body as an airfoil, or may have airfoil attachments that can increase airfoil effects of the UAV body.

The UAV may have one or more mounting sites with may be configured to accept an extension. In some instances, the same extension may be attached to different mounting sites. Examples of extensions may include, but are not limited to, landing gear, propeller protectors, arms supporting one or more propellers, tripods, selfie sticks, handheld supports, and/or camera mounts. The use of extensions may provide increased flexibility in how the UAV is used. For instance, the UAV may be well suited for both aerial and land-based photography.

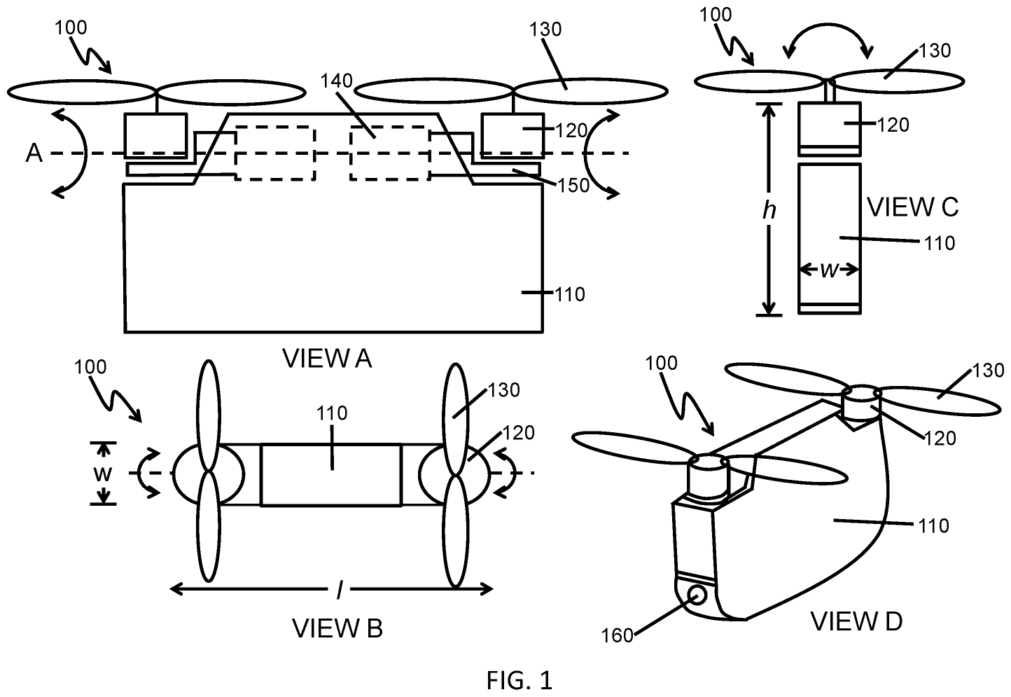

FIG. 1 shows an example of an unmanned aerial vehicle (UAV), in accordance with embodiments of the disclosure. View A shows a side view of the UAV, View B provides a top view of the UAV, View C shows an end view of the UAV, and View D shows an oblique view of the UAV.

The UAV 100 may comprise a central body 110. The central body may support one or more propeller seats 120 and propellers 130. In some embodiments, the propeller seats and/or propellers may be capable of changing orientation relative to the central body with aid of one or more actuators 140 and propeller supports 150. The UAV may also carry a load 160.

Any description herein of a UAV 100 may apply to any type of movable object, and vice versa. A movable object may be any object capable of moving within an environment. The movable object may be capable of self-propulsion. The movable object may be capable of navigating any type of environment, such as air, land, water, and/or space. The movable object may be capable of flight. The movable object may comprise one or more propulsion units that may aid in movement of the movable object. The propulsion units may enable the movable object to be self-propelled without requiring human intervention. The propulsion units may include an actuator that may operate on electrical, magnetic, electromagnetic, chemical, biochemical, thermal, photovoltaic, or any other type of energy. The movable object may have any characteristic as described in detail elsewhere herein. The movable object may be a UAV. Any description herein of a movable object may apply to a UAV or any other type of movable object. Similarly, any description herein of a UAV may apply to any movable object, or specific type of movable object.

The movable object may be capable of any type of motion. For instance, the movable object may be capable of translation with respect to one, two, or three axes. The movable object may be capable of rotation about one, two, or three axes. The axes may be orthogonal to one another. The axes may comprise a yaw axis, pitch axis, and/or roll axis of the movable object.

The UAV may operate autonomously, semi-autonomously, or manually in response to input provided by a user via a remote terminal. In some instances, a user may operate the UAV in a manual direct manner such that the UAV may respond directly to inputs provided by the UAV via the remote terminal. In some instances, the UAV may operate semi-autonomously. The UAV may fly in a certain manner or pattern in response to an input by the user via the remote terminal. In some instances, the UAV may fly in a fully autonomous manner without requiring inputs via the remote terminal. The UAV may fly autonomously to execute a goal or mission. The UAV may or may not automatically avoid obstacles.

In some instances, a communication link may be established between the UAV and the remote terminal. The communication link may be a wireless communication link. The communication link may be a direct communication link or an indirect communication link. For example, direct communications may be provided between the UAV and the remote terminal (e.g., Bluetooth, infrared, WiFi, etc.). In some instances, indirect communications may be provided between the UAV and the remote terminal. The indirect communications may include communications over a network and/or through one or more intermediary devices. Communications may occur over a telecommunications network, data network, WAN, LAN, or any other type of network. Communications may pass through intermediary devices such as satellites, telecommunication towers, routers, etc.

The UAV 100 may comprise a central body 110. The central body may also be referred to as a fuselage. The central body may house one or more electrical components therein. The central body may comprise a housing that may partially or completely enclose one or more electrical components therein. Examples of components that may be housed by the central body may include a power source, a flight controller, communication unit, one or more sensors, location units, actuators, and/or any other type of component. A housing may be formed from a single piece or from multiple pieces. The multiple pieces may include a right side and a left side of the central body. The multiple pieces may include a top portion and a bottom portion of the central body. The housing portions may or may not be separated by a user to access the one or more electrical components therein.

The central body may have any form factor. In some embodiments, a central body may have one or more lateral dimensions, such as a length land a width w. The central body may have a vertical dimension, such as height h. In some embodiments, the central body may have a narrow shape. For instance, the width of the central body may be less than a length the central body. The width of the central body may be significantly less than the length of the central body In some embodiments, a ratio of a length of the central body to the width of the central body l:w may be greater than or equal to about 3:2, 2:1, 3:1, 4:1, 5:1, 6:1, 7:1, 8:1, 9:1, 10:1, 12:1, 15:1, 20:1, 30:1, or 40:1. The width of the central body may be small enough to reduce obstruction of downward airflow generated by the rotor blades. In some embodiments, the width of the central body may be less than or equal to about 10 cm, 7 cm, 6 cm, 5 cm, 4 cm, 3.5 cm, 3 cm, 2.5 cm, 2 cm, 1.5 cm, 1.2 cm, 1 cm, 0.7 cm, 0.5 cm, 0.3 cm, 0.1 cm, 0.05 cm, or 0.01 cm. In some embodiments, the width of the central body may be significantly less than a length of a rotor blade of a propeller of the UAV. In some instances, a ratio of a length of the rotor blade of the propeller to a width of the central body may be greater than or equal to about 3:2, 2:1, 3:1, 4:1, 5:1, 6:1, 7:1, 8:1, 9:1, 10:1, 12:1, 15:1, 20:1, 30:1, or 40:1.

A lateral dimension of the central body may be substantially less than a vertical dimension of the central body. In some embodiments, a width of the central body may be substantially less than a height of the central body. For instance, a ratio of a height of the central body to the width of the central body h:w may be greater than or equal to about 3:2, 2:1, 3:1, 4:1, 5:1, 6:1, 7:1, 8:1, 9:1, 10:1, 12:1, 15:1, 20:1, 30:1, or 40:1. In some instances, a length of the central body may or may not be less than a height of the central body. A length of the central body may or may not be greater than a height of the central body. In some instances, a ratio of a height of the central body to the length of the central body h:l may be greater than or equal to about 1:10, 1:9, 1:8, 1:7, 1:6, 1:5, 1:4, 1:3, 1:2, 2:3, 1:1, 3:2, 2:1, 3:1, 4:1, 5:1, 6:1, 7:1, 8:1, 9:1, 10:1, 12:1, 15:1, 20:1, 30:1, or 40:1. The ratio of the height of the central body to the length of the central body may be less than any of the ratio values provided, or fall within a range between any two of the ratio values provided. A longitudinal axis may extend along a length of the central body. A vertical axis may extend along a height of the central body.

The overall central body may be substantially portable. The central body may have a length of less than or equal to about 50 cm, 40 cm, 30 cm, 25 cm, 20 cm, 17 cm, 15 cm, 14 cm, 13 cm, 12 cm, 11 cm, 10 cm, 9 cm, 8 cm, 7 cm, 6 cm, 5 cm, 4 cm, 3.5 cm, 3 cm, 2.5 cm, 2 cm, 1.5 cm, 1.2 cm, 1 cm, 0.7 cm, 0.5 cm, 0.3 cm, 0.1 cm, 0.05 cm, or 0.01 cm. The central body may have a length greater than any of the values provided herein or falling within range between any two of the values provided herein. The central body may have a height of less than or equal to about 50 cm, 40 cm, 30 cm, 25 cm, 20 cm, 17 cm, 15 cm, 14 cm, 13 cm, 12 cm, 11 cm, 10 cm, 9 cm, 8 cm, 7 cm, 6 cm, 5 cm, 4 cm, 3.5 cm, 3 cm, 2.5 cm, 2 cm, 1.5 cm, 1.2 cm, 1 cm, 0.7 cm, 0.5 cm, 0.3 cm, 0.1 cm, 0.05 cm, or 0.01 cm. The central body may have a height greater than any of the values provided herein or falling within a range between any two of the values provided herein. A maximum dimension of the UAV (e.g., diagonal, diameter, length, width, or height) may be less than or equal to any of the measurements provided herein. The central body may have weight of less than or equal to about 5 kg, 3 kg, 2 kg, 1.5 kg. 1.2 kg, 1 kg, 0.8 kg, 0.7 kg, 0.6 kg, 0.5 kg, 0.4 kg, 0.3 kg, 0.25 kg, 0.2 kg, 0.15 kg, 0.12 kg, 0.1 kg, 0.07 kg, 0.05 kg, 0.04 kg, 0.03 kg, 0.02 kg, 0.01 kg, 0.005 kg, or 0.001 kg.

The central body may have any form factor. The central body may have a substantially vertically aligned flat body. The central body may be shaped to provide less than a predetermined threshold of air resistance in a direction of flight. The central body may be shaped to provide a high lift to drag ratio during flight. In some embodiments, the lift to drag ratio may be greater than or equal to about 0.5, 1, 1.5, 2, 2.5, 3, 4, 5, 6, 7 or 10 during normal flight. The central body may have a similar form factor (e.g., size, or proportion of dimensions) to a smartphone, tablet, or laptop computer. The central body may have a similar form factor to a book that is arranged vertically. The central body may have a substantially rectangular prism shape. The corners of the central body may be sharp or may be rounded. The edges and/or sides of the central body may be sharp or may be rounded. The central body may fit ergonomically into a hand of a user. The central body may be handheld. The central body may be configured to be held by a single hand of a user. The user may easily grip the central body between a thumb and fingers. The central body may have a portable and ergonomic shape that may permit handheld imaging with aid of an imaging device supported by the central body.

A lateral dimension of the central body (e.g., width, length) may be sufficiently small to permit the UAV to land or takeoff from a user's hand, optionally while allowing a user's hand to grasp opposing sides of the central body. For instance, a user may grasp opposing sides of the UAV in the user's hand, and then may release the UAV when the UAV takes off from the user's hand. The user may also catch a UAV that is landing and grasp the opposing sides of the UAV when it has landed.

A vertical dimension of the central body may be sufficiently large to allow the UAV to takeoff from a user's hand or land on the user's hand without he user's hand coming into contact with one or more rotor blades when the user's hand grasps opposing sides of the central body. The vertical dimension of the central body may be greater than the length of the user's fingers. The vertical dimension of the central body may be greater than the length of the user's fingers coupled with a portion a palm that may fold around the central body.

In some embodiments, a UAV may primarily travel in a direction along a longitudinal axis of the UAV. During normal flight, the UAV may fly in a direction along a longitudinal axis of the UAV. The UAV may be flying in a direction of a narrow end of the central body, as opposed to a wider side surface of the central body. This may provide reduced wind resistance caused by the narrow central body of the UAV. The UAV may also fly up and down. This may also provide reduced wind resistance caused by the narrow central body of the UAV.

A UAV 100 may comprise one or more propulsion units that may aid in movement of the UAV. The propulsion units may comprise one or more propellers 130. The propulsion units may comprise one or more propeller seats 120 which may be configured to accept the one or more propellers. The propeller may or may not be detachable from the propeller seat. The propulsion seat may optionally comprise a shaft driven by an actuator and configured to effect rotation of one or more propellers. The actuator may be part of the propulsion unit. The actuator may be part of the propeller seat. The actuator may be supported within a housing of the propeller seat. The actuator may be a motor. The motor rotation may be controlled with aid of one or more electric speed controls (ESCs). The ESCs may control motor rotation speed and/or direction. The ESCs may be located in the propeller seat, or within the central body of the UAV.

The one or more propellers 130 may rotate to generate lift and/or thrust for the UAV. A propeller may comprise one, two, three, four, or more rotor blades. The rotor blades may or may not extend from a hub. The rotor blades may or may not extend from a shaft or one or more pins of the propeller seat. In one example, multiple rotor blades may be attached to a single shaft. The rotor blade may or may not rotate independently of one another. In another example, multiple pins may be provided, and each pin may support an individual rotor blade. The multiple pins may rotate about a shaft which may drive rotation of the pins and/or any support for the pins. The rotor blades may be stationary relative to the hub and/or one another. In some instances, the rotor blades may be movable relative to the hub and/or one another. One or more actuators, such as one or more motors may control rotation of the one or more propellers. A motor may be coupled to a shaft that may be coupled directly or indirectly to one or more propellers. The motors may be in communication with a controller on-board the UAV. The controller may generate one or more flight commands that may be delivered to the one or more motors to affect rotation of the one or more propellers. Faster rotation of the propellers may generate more lift than slower rotation of the propellers.

The propulsion units may be supported by the central body 110. The central body may bear weight of the propulsion units. The propulsion units may be directly supported by the central body. The propulsion units may be supported by the central body without use of arms extending from the central body. In some embodiments, the UAV may not comprise any permanent arms extending away from the central body. In some embodiments, the propulsion units may be supported on a top surface of the central body. Alternatively or in addition, the propulsion units may be supported on a side surface, front surface, rear surface, and/or bottom surface of the central body. The propulsion units may be supported at distal ends of the central body along a longitudinal axis of the central body, extending along the length of the central body. The propulsion units may be provided at or near the ends along the longitudinal axis of the central body. The propulsion units may be within 1%, 3%, 5%, 10%, 15%, 20%, 25% or 30% of the end of the length of the central body. The propulsion units may be supported on a top surface of the central body at or near the distal ends of the central body. The shafts of the propulsion units may be provided above the central body. The hubs of the propulsion units may be provided above the central body. The motors of the propulsion units may be supported above the central body.

Any number of propulsion units may be provided on the UAV. Any number of propulsion units may be directly supported by the central body. In some embodiments, one or more, two or more, three or more, four or more, five or more, six or more, eight or more, ten or more, or twenty or more propulsion units may be directly supported by the central body. The propulsion units may be arranged in a row along a longitudinal axis of the central body. In one example, two propulsion units may be provided. The each propulsion unit may be at opposing distal ends along the longitudinal axis of the central body. The UAV may be a dualcopter. The dualcopter may have two propulsion units. In some embodiments, a dualcopter may advantageously permit controlled and stable flight of the UAV by controlling the rotation angle and rotation speed of the motors and propellers, where rotation angle can be controlled by a servo motor and the rotation speed can be controlled by an electronic speed control. This may provide advantages over a quadcopter, which may rely purely on the rotational speed of the motors to control attitude and speed of the UAV, but has a relatively short flight time. The dualcopter as provided may provide an increased flight time over the quadcopter. The dualcopter may also provide advantages over a helicopter which has a primary propeller using a complex swashplate to tilt in various directions and a secondary propeller for counterbalancing the torque of the primary propeller, which results in a very complex structure. The dualcopter may provide a simplified structure that may provide stable flight, relative to the helicopter. The dualcopter may also provide a simplified structure that may allow the UAV to quickly and simply takeoff and/or land without requiring any folding, expanding, and/or compacting steps.

In some embodiments, an orientation of one or more propulsion units may be adjustable relative to the central body. The orientation of the one or more propulsion units may be manually adjusted, or may be adjusted with aid of one or more actuators 140. The one or more actuators may be a motor, such as a servomotor or stepper motor. The orientation of the one or more propulsion units may be adjustable by permitting rotation of the one or more propulsion units around one, two, three, or more axes. In one example, at least one propulsion unit may be capable of rotating about a longitudinal axis extending along a length of the central body. In another example, at least one propulsion unit may be capable of rotation about two orthogonal axes or three orthogonal axes. One or more of the orthogonal axes may be a longitudinal axis extending along a length of the central body. One or more of the orthogonal axes may be a vertical axis extending along a height of the central body. One or more of the orthogonal axes may be a width axis extending along a width of the central body.

The adjustment of the orientation of the propulsion units may permit improved flight performance. In some embodiments, adjustment of the orientation of the propulsion units may be provided to counteract external disturbance forces. Orientation of one or more propulsion units may occur to provide improved maneuverability of the UAV. In some instances, one or more propulsion units may be adjusted to tilt the central body to utilize lift forces generated from wind. One or more propulsion units may be adjusted to cause a UAV to change between a right-side up flying mode and an upside down flying mode.

Additionally or alternatively to adjusting an orientation of a propulsion unit relative to the central body, one or more actuators may be configured to cause at least one of the propulsion units to move in a translational manner relative to the central body.

In some embodiments, one or more actuators 140 may be positioned on or in a central body 110. The actuator may cause movement of a propeller support 150. For example, the actuator may rotate, which may cause corresponding rotation of the propeller support. The propeller support may support a propulsion unit, such as a propeller seat 120 and/or propeller 130. The propeller support may bear weight of the propulsion unit. When the propeller support rotates or moves in any other manner, the propulsion unit may make corresponding movements. For example, if the propeller support rotates about a longitudinal axis in response to the rotation of the actuator, the propulsion unit may correspondingly rotate about a longitudinal axis. The rotational axis may or may not intersect the propulsion unit. The rotational axis may or may not intersect the propeller support. The rotational axis may or may not intersect a propeller seat. The rotational axis may or may not intersect the propeller itself.

The one or more actuators may control the orientation and/or translational position of the propulsion units relative to the central body in response to one or more commands. The one or more commands may be generated with aid of a flight controller on-board the UAV. The UAV may have multiple sets of actuators that may be controlled by a flight controller on-board the UAV. A first set of actuators may control rotation of the propellers relative to the propeller seat. A second set of actuators may control rotation of the propulsion units relative to the central body. The axes of rotation of the first set of actuators may be orthogonal to the axes of rotation of the second set of actuators. The rotation effected by the second set of actuators may cause change in the orientation of the axes of rotation of the first set of actuators. The orientation of the propulsion units may be adjusted during flight of the UAV. The orientation of the propulsion units may be controlled in real-time as needed to execute the desired flight maneuver.

The orientation of the propulsion units may be controlled independently of one another. For example, if two propulsion units are provided, their angle relative to the central body may be controlled independently of one another. Alternatively or in addition, the orientation of the propulsion units may be controlled together. In some embodiments, orientation of the propulsion units may be maintained relative to one another so that they have the same angle relative to the central body. In some instances, the one or more rotor blades may remain parallel to one another as the orientation of the propulsion units may be controlled. In some instances, the one or more rotor blades may be me at oblique angles relative to one another.

The UAV may optionally support a load 160. The load may or may not comprise one or more carriers (e.g., gimbals). The carriers may be part of the movable object or may be separate from the movable object. The carriers may be mechanically and/or electrically connected to the movable object. A controller of the UAV or separate from the controller of the UAV may issue one or more commands that may affect operation of the carriers. In some embodiments, the load may comprise a payload. In some instances, a load may comprise a payload without requiring a carrier. The payload may be fixed relative to the central body or may be movable relative to the central body with or without aid of a carrier.

One or more carriers may each support one or more payloads. In some embodiments, each carrier may support a payload. The carrier may bear weight of the corresponding payload. The carrier may control spatial disposition of the payload. The carrier may control orientation of the payload with respect to the movable object. The carrier may control orientation of the payload about one axis, two axes, or three axes, with respect to the movable object. The carrier may permit rotation of the payload about one axis, two axes, or three axes, with respect to the movable object. The axes may be orthogonal to one another. The axes may comprise a yaw axis, pitch axis, and/or roll axis of a payload supported by the corresponding carrier. The carrier may control a rotational angle of the payload with respect to a yaw axis alone, pitch axis alone, roll axis alone, yaw and pitch axis, pitch and roll axis, roll and yaw axis, or a yaw axis, pitch axis, and roll axis.

Each carrier may be a gimbal. The gimbal may be a one-axis gimbal, two-axis gimbal, or three-axis gimbal. The gimbal may comprise a frame assembly and a motor assembly. The frame assembly may comprise one or more frame components that may rotate relative to one another and/or the movable object. In one example, a gimbal assembly may comprise a first frame component that may support the payload. The payload may rotate relative to the first frame component or may rotate relative to the first frame component. The first frame component may be directly connected to the platform, or may be supported by a second frame component. The first frame component may rotate relative to the second frame component. The second frame component may bear weight of the first frame component. The second frame component may be directly connected to the platform, or may be supported by a third frame component. The third frame component may bear weight of the second frame component. The second frame component may rotate relative to the third frame component. The third frame component may bear weight of the second frame component. Any number of additional frame components may be presented.

The motor assembly may permit the frame assemblies to rotate relative to one another. For example, a first motor may permit a first frame assembly to rotate relative to the second frame assembly. A second motor may permit a second frame assembly to rotate relative to the third frame assembly. A third motor may permit a third frame assembly to rotate relative to the platform. Any number of motors may be provided. For instance, one or more, two or more, three or more, four or more, five or more, six or more, or seven or more motors may be employed.

The gimbal may comprise one or more sensors that may detect disposition and/or movement of one or more components of the gimbal. For example, the one or more sensors may be disposed on the frame assembly and/or one or more sensors may be disposed on the motor assembly. One or more sensors may be disposed on a first frame component, second frame component, and/or third frame component. One or more sensors may be disposed on or incorporated into a first motor, second motor, and/or third motor. One or more sensors may be disposed on the payload itself. One or more sensors may be disposed on the movable object. The one or more sensors may comprise inertial sensors. Inertial sensors may comprise, but are not limited to, accelerometers, gyroscopes, magnetometers, or gravity-based sensors. The inertial sensors may detect an orientation of the respective component on which it is disposed with respect to one axis, two axes, or three axes. The inertial sensors may detect movement of the respective component, such as linear velocity, angular velocity, linear acceleration, and/or angular acceleration of the respective component. The inertial sensors may be useful for detecting how a payload is oriented relative to the movable object or an inertial reference frame (e.g., the environment). The inertial sensors may be useful for detecting how a payload is moving relative to the movable object or an inertial reference frame. The inertial sensors may be useful for detecting how a respective component by which it is supported is oriented relative to the movable object or an inertial reference frame. The inertial sensors may be useful for detecting how a respective component by which it is supported is moving relative to the movable object or an inertial reference frame.

The load may comprise a payload. The load may comprise a payload without a carrier, or may comprise a carrier and a payload. The payload may comprise one or more sensors. Any sensor suitable for collecting environmental information can be used, including location sensors (e.g., global positioning system (GPS) sensors, mobile device transmitters enabling location triangulation), vision sensors (e.g., imaging devices capable of detecting visible, infrared, or ultraviolet light, such as cameras), proximity sensors (e.g., ultrasonic sensors, lidar, time-of-flight cameras), inertial sensors (e.g., accelerometers, gyroscopes, inertial measurement units (IMUs)), altitude sensors, pressure sensors (e.g., barometers), audio sensors (e.g., microphones) or field sensors (e.g., magnetometers, electromagnetic sensors). Any suitable number and combination of sensors can be used, such as one, two, three, four, five, or more sensors. Optionally, the data can be received from sensors of different types (e.g., two, three, four, five, or more types). Sensors of different types may measure different types of signals or information (e.g., position, orientation, velocity, acceleration, proximity, pressure, etc.) and/or utilize different types of measurement techniques to obtain data. For instance, the sensors may include any suitable combination of active sensors (e.g., sensors that generate and measure energy from their own source) and passive sensors (e.g., sensors that detect available energy).

In one example, the payload may be an imaging device. An imaging device may be a physical imaging device. An imaging device can be configured to detect electromagnetic radiation (e.g., visible, infrared, and/or ultraviolet light) and generate image data based on the detected electromagnetic radiation. In some embodiments, a payload may be a camera. The payload may be a camera that images an environment anywhere along an electromagnetic spectrum. For example, the payload may be a visible light camera. The payload may be an infrared camera. The payload may be an ultraviolet camera. The camera may be a night-vision camera. The payload may be a camera that may sense and visualize vibrations, sounds, reflected light, radiation, or any other condition of the environment that may be visualized.

An imaging device may include a charge-coupled device (CCD) sensor or a complementary metal-oxide-semiconductor (CMOS) sensor that generates electrical signals in response to wavelengths of light. The resultant electrical signals can be processed to produce image data. The image data generated by an imaging device can include one or more images, which may be static images (e.g., photographs), dynamic images (e.g., video), or suitable combinations thereof. The image data can be polychromatic (e.g., RGB, CMYK, HSV) or monochromatic (e.g., grayscale, black-and-white, sepia). The imaging device may include a lens configured to direct light onto an image sensor. The UAV may be used for aerial photography with aid of the payload.

In some embodiments, the imaging device can be a camera. A camera can be a movie or video camera that captures dynamic image data (e.g., video). A camera can be a still camera that captures static images (e.g., photographs). A camera may capture both dynamic image data and static images. A camera may switch between capturing dynamic image data and static images. Although certain embodiments provided herein are described in the context of cameras, it shall be understood that the present disclosure can be applied to any suitable imaging device, and any description herein relating to cameras can also be applied to any suitable imaging device, and any description herein relating to cameras can also be applied to other types of imaging devices. A camera can be used to generate 2D images of a 3D scene (e.g., an environment, one or more objects, etc.). The images generated by the camera can represent the projection of the 3D scene onto a 2D image plane. Accordingly, each point in the 2D image corresponds to a 3D spatial coordinate in the scene. The camera may comprise optical elements (e.g., lens, mirrors, filters, etc). The camera may capture color images, greyscale image, infrared images, and the like. The camera may be a thermal imaging device when it is configured to capture infrared images.

The payload may make an emission into the environment. For example, the payload may comprise a microphone that may emit sound into the environment. The payload may comprise a light source that may emit a light into the environment. The emission may be directed. For example, having a UAV with multiple gimbals may be useful when one of the payloads is a light source and another payload is a visible light camera, particularly when the UAV is flying in the night or within an area with low lighting (e.g., indoors, caves, cave-ins, etc.).

The payload may permit interaction with the environment. For example, the payload may comprise a robotic arm. The robotic arm may be capable of gripping and/or picking up objects. Having a UAV with multiple gimbals may be useful when one of the payloads is a camera and the other payload is a robotic arm, particularly when the UAV is flying and interacting with an environment. The camera may detect an object for the UAV to pick up. This may be particularly useful in sample-collection applications where the UAV with multiple gimbals may expand the range of collection. In another example, the payload may be a delivery system that may spray objects, such as pesticides or water where needed.

The UAV may be useful for aerial photography and/or handheld photography. A payload, such as a camera, may be configured to capture images while the UAV is in flight, and while the UAV is grasped within a user's hand (or supported by an extension held by the user's hand).

The load may or may not be detachable from the UAV. The load may be controlled automatically in response to one or more commands generated by one or more processors on-board the UAV. The one or more processors may be provided within the central body. The one or more processors may be part of a flight controller or may be in communication with a flight controller. The carrier and/or the payload may be controlled in response to the one or more commands from the processors on-board the UAV. In some embodiments, the load may be controlled in response to one or more commands provided by a remote terminal to the UAV. The remote terminal may be configured to accept a user input that may generate the one or more commands to control the load. The carrier and/or payload in may be controlled in response to user input at a remote terminal. The remote terminal may control both flight of the UAV and the load of the UAV. Alternatively, different remote terminals may be used to control the flight of the UAV and the load of the UAV.

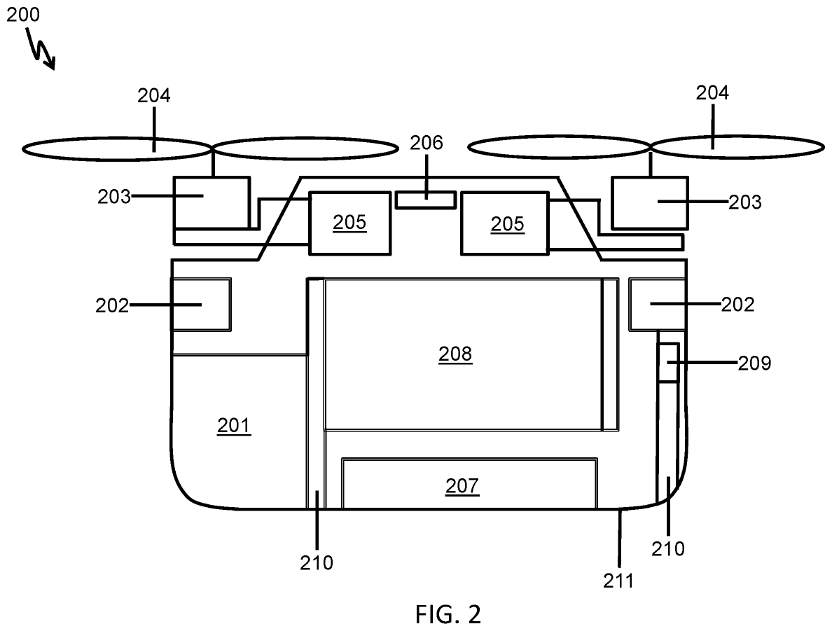

FIG. 2 shows an example of a UAV with a possible internal layout, in accordance with embodiments of the disclosure. A UAV 200 may comprise one or more modules or components. Such arrangement is provided by way of example, and is not limiting.

The UAV may comprise a camera module 201. The camera module may be provided on-board a central body of the UAV. The camera module may be integrated into the central body of the UAV, permanently attached to the central body, or may be removably attached to the central body. The camera module may have a compact size and/or shape. The camera module may be less than 1 cm³, 2 cm³, 3 cm³, 4 cm³, 5 cm³, 6 cm³, 7 cm³, 8 cm³, 9 cm³, 10 cm³, 12 cm³, or 15 cm³ in volume. The camera module may be attached to the central body in a seamless manner. The camera module may optionally not protrude significantly from the central body. The camera module may be integrated along the contours of the central body. This may reduce wind resistance effects and/or reduce likelihood that the camera module may become damaged. This may also provide increased flexibility with landing gear formats since the camera module will not extend out significantly (protruding camera modules may require landing gear to elevate the camera module off a surface when the UAV is not in flight).

The camera module may comprise a payload, such as a camera, or any other type of payload as described elsewhere herein. The camera module may comprise a carrier, such as a gimbal, as described elsewhere herein. The gimbal may be a one-axis gimbal, two-axis gimbal, or three-axis gimbal. The payload may be supported by the carrier. The carrier may be used to control the orientation of the payload relative to the central body. For instance, the carrier may be used to control the orientation of a camera relative to the central body.

The UAV may comprise one or more obstacle avoidance sensors 202. The one or more obstacle avoidance sensors may comprise one or more different types of sensors. The obstacle avoidance sensors may comprise any of the types of sensors, as described elsewhere herein. The obstacle avoidance sensors may be capable of detecting one or more obstacles within a given range of the UAV. The obstacle avoidance sensors may be capable of detecting physical obstacles within a given distance and/or angle of view. For instance, the obstacle avoidance sensors may be able to detect physical obstacles early enough to provide UAVs with sufficient time take avoidance measures. The obstacle avoidance sensors may be capable of detecting objects within 500 m, 400 m, 300 m, 200 m, 150 m, 100 m, 90 m, 80 m, 70 m, 60 m, 50 m, 40 m, 30 m, 20 m, 15 m, 10 m, 5 m, or 1 m of the UAV.

The obstacle avoidance sensors may be placed at one or more, two or more, three or more, four or more, five or more, ten or more, or twenty or more different locations on the UAV. For instance, the obstacle avoidance sensors may be provided at opposing ends of the UAV central body. In some instances, the obstacle avoidance sensor may be provided on opposing sides of the UAV central body. The obstacle avoidance sensors may be provided on a top surface and/or bottom surface of the UAV. The obstacle avoidance sensors may be capable of detecting obstacles within at least a 90 degree range, 180 degree range, 270 degree range, or 360 degree range horizontally around the UAV. The obstacle avoidance sensors may be capable of detecting obstacles within at least a 90 degree range, 180 degree range, 270 degree range, or 360 degree range vertically around the UAV.

The obstacle avoidance sensors may be integrated into the central body of the UAV, permanently attached to the central body, or may be removably attached to the central body. The obstacle avoidance sensors may be static relative to the central body or may be movable relative to the central body. Based on data collected by the obstacle avoidance sensors, the UAV may be able to take obstacle avoidance maneuvers. The UAV may automatically take obstacle avoidance maneuvers without requiring any input from a user.

The UAV may comprise one or more propeller seats 203. A propeller seat may comprise a motor configured to drive rotation of one or more propellers 204. The motor may be coupled to a shaft. Rotation of the motor may cause rotation of the shaft. The rotation of the shaft may cause rotation of one or more propellers. The propellers may or may not be detachable from the shaft. In some embodiments, each motor of the UAV may drive one or more propellers. The motors on the UAV may rotate in the same direction or may rotate in different directions. In some instances, the same number of motors may be rotating in a first direction, as the number of motors rotating in the second direction different from the first direction. In one example, two motors may be provided for driving rotation of the propellers. A first motor may rotate in a clockwise direction and a second motor may rotate in a counterclockwise direction. The corresponding propellers may rotate in a clockwise direction and a counterclockwise direction. This may allow offset of torque generated by the propeller rotation and permit stable flight. The speed of rotation of the motors and/or the corresponding propellers may be independently controlled. For instance, a speed of rotor blades of a first propulsion unit may be independent of a speed of rotation of the rotor blades of a second propulsion unit.

The propellers 204 may comprise one or more blades. The one or more blades may optionally be fixed to a hub. The propeller may be directly or indirectly coupled to a shaft. In some instances one or more adapters or intermediary mechanisms may be provided between the propellers and the shaft. The blades of the propeller may or may not be foldable.

The orientation of the motors and/or propellers relative to the central body may be adjustable. In some embodiments, one or more actuators 205 may be provided that may control the orientation of the propeller seats (e.g., motors) and/or propellers relative to the central body. The actuators may be servomotors or other types of actuators that may control rotation of the propeller seats and/or propellers about one or more axes. For instance, the actuators may be oriented to cause the propeller seats and/or propellers to rotate about a longitudinal axis of the UAV.

In some embodiments, orientation of each propeller seat and/or propeller may be controlled by a respective actuator. For instance, a first actuator may maintain and/or vary orientation of a first propeller seat and first propeller, while a second actuator may maintain and/or vary orientation of a second propeller seat and a second propeller. The orientations of each propeller seat and corresponding propeller may be independently controlled from one another. Alternatively, they may be controlled together. For instance, they may be controlled to have the same orientation. In some embodiments, a single actuator may control orientation of multiple propeller seats and corresponding propellers.

Orientation of the propulsion units (e.g., propellers, motors, and/or propeller seats) may be controlled by controlling an aileron or other pneumatic curved surface. The control of the orientation based on the surface shape may be provided in addition to, or an alternative to, control by actuators.

A UAV may also comprise one or more additional sensors 206. The additional sensor may be a location sensor, such as a GPS sensor. The one or more additional sensors may comprise one or more obstacle avoidance sensors. The sensor may be positioned at or near a top surface of the UAV. In some embodiments, it may be advantageous to provide location sensors at or near a top surface of the UAV to aid in collection of signals from objects, such as satellites.

Additional, a UAV may also comprise a downward facing positioning system 207. The downward facing positioning system may comprise one or more sensors. The one or more sensors may be any type of sensors, such as those described elsewhere herein. In some instances, the one or more sensors may comprise multiple types of sensors. For instance, the one or more sensors may comprise vision sensors, infrared sensors, ultrasonic sensors, lidar, and/or any other type of sensors.

The downward facing positioning system may be useful for automatic recognition of landing surfaces. The landing surface may be a ground, structure (e.g., building, wall, roof, table, pole, fence, landing pad, etc.), and/or a body part of the user (e.g., user's hand). The positioning system may be useful for recognizing type and/or positioning of the landing surface. The data from the positioning system may be provided to a flight controller.

The flight controller may issue commands to the motors that control rotation of the propellers and/or actuators that control orientation of the propellers. The flight controller may issue commands based on information from one or more sensors, such as the obstacle avoidance sensors, location sensors, and/or downward facing positioning system. In some instances, the data from the downward facing positioning system may be used to control flight of the UAV to land at a desire position on the landing surface. For example, the system may aid in guiding the UAV to land on a user's hand.

A power source 208, such as a battery, may be provided on-board the UAV. The battery may be provided on or in the central body of the UAV. The battery may or may not be removable from the central body of the UAV. The battery may be rechargeable. The battery may be recharged while on-board the UAV. Alternatively or in addition, the battery may be recharged when removed from the UAV, and then returned back into the UAV.

The power source may provide power for one or more components of the UAV. For instance, the power source may provide power to a camera module, one or more sensors (e.g., obstacle avoidance sensors, location sensors, downward facing positioning system), one or more actuators (e.g., motors that control rotation of the propeller, motors that control orientation of the propellers), communication systems, navigation systems, flight controller, or any other components of the UAV.

In some embodiments, the UAV may be capable of flying for at least 5 minutes, 10 minutes, 15 minutes, 20 minutes, 30 minutes, 45 minutes, 1 hour, 1.5 hours, 2 hours, 3 hours, 4 hours, 5 hours, 6 hours, or 10 hours on a single charge of the power source. The configuration of the central body may aid in reduction of drag forces, which may save energy, and provide an extended flight time off a single charge.

A UAV may comprise a communication unit 209. The communication unit may be a near field communication (NFC) patch. When a mobile device, such as a smartphone, having an NFC chip comes into contact with the patch, communication can be established automatically with the UAV. A user can interact with the UAV through the mobile device. For example, a user can open a mobile application on the mobile device, and control the UAV through the mobile application. The user may or may not also be able to control the payload of the UAV (e.g., camera) of the UAV through the mobile application. For instance, the user may or may not be able to control movement of the camera relative to the UAV central body.

An antenna 210, such as a vertical-type antenna, may be provided on-board the UAV. The antenna may be able to receive and/or send omnidirectional signals. Alternatively, the antenna may be a directional antenna that may receive and/or send stronger signals in a particular direction compared to other directions. The antenna may have a long transmission distance. The antenna may allow the UAV to communicate directly with the user device, such as the mobile device with the mobile application. Alternatively, indirect communications may be provided between the UAV and the user device.

Optionally, a UAV may comprise a housing 211. The housing may be provided for the central body. The housing may partially or completely enclose one or more components of the UAV, such as any of the components described elsewhere herein. The housing may be formed from a single piece or multiple pieces. Multiple pieces of the housing may or may not be separable. In some instances, the housing may comprise a door or opening that may allow a user to access one or more components within the housing. The user may or may not remove a component of the UAV from the housing.

The UAV may comprise one or more processors that may execute code, logic or instructions for performing one or more steps. The one or more processors may receive information from one or more components on-board the UAV and/or one or more devices off-board the UAV. For instance, one or sensors, modules, payloads, carriers, actuators, motors, power sources, and/or communication units may provide information to one or more processors of the UAV. One or more remote terminals may provide information that may be received by the UAV and ultimately received by one or more processors of the UAV. The one or more processors may generate one or more sets of instructions or commands for one or more components of the UAV. For instance, commands may be sent to one or more motors controlling rotation of propellers of the UAV, one or more actuators controlling orientation of one or more propellers of the UAV, one or more carriers that may affect orientation of a payload of the UAV, one or more payloads that may affect operation of the payload, one or more sensors that may affect operation of the sensors, and/or one or more communication units which may effect operation of the communication unit or data sent via the communication unit. The commands may be generated based on information received. One or more processors may function as a flight controller, load controller, or any combination thereof.

The UAV may comprise one or more memory storage units comprising non-transitory computer readable media comprising code, logic or instructions for performing one or more steps.

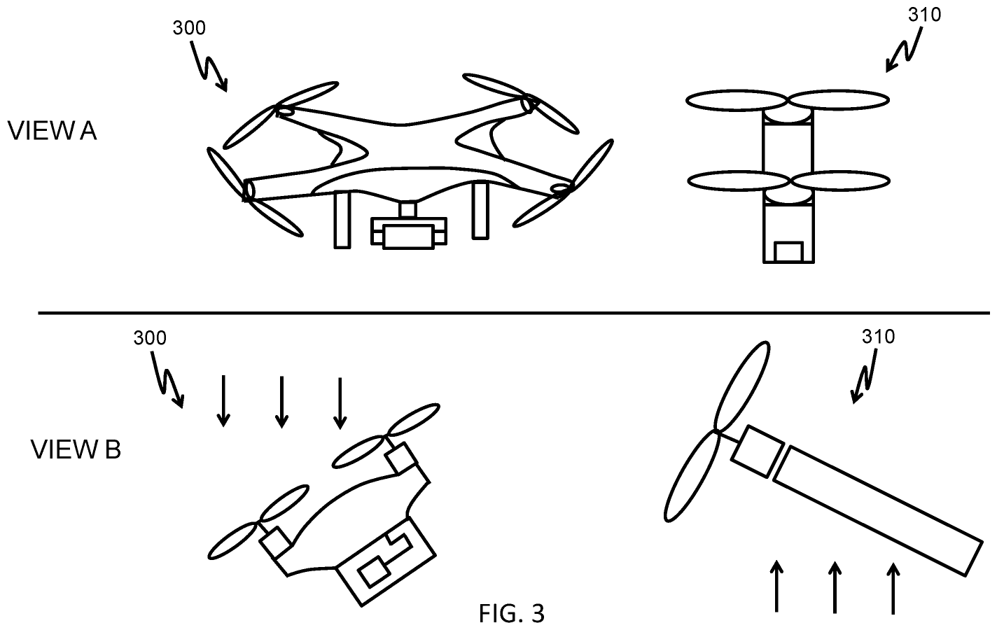

FIG. 3 shows examples of wind effects on UAVs, in accordance with embodiments of the disclosure. The UAV may be configured with a narrow central body that may reduce undesirable effects of wind on the UAV.

View A shows an example of a traditional quadcopter 300 as well as an example of a UAV 310 with a narrow body, as provided herein. During flight of the quadcopter, the widespread footprint of the quadcopter provides a large degree of wind resistance. For example, when the quadcopter is rising into the air, the widespread body of the quadcopter may cause a significant amount of wind resistance, which may provide increased drag and take up more energy for the quadcopter to fly. Similarly, when the quadcopter is going forwards and backwards, there is still a large lateral footprint which may also result in a large degree of wind resistance and energy usage to counteract the wind resistance.

During flight of the narrow body UAV 310, the effects of wind resistance may be reduced. For instance, when the UAV is rising into the air, the narrow body provides a reduced surface area that may be in the direction of flight. The narrow body may also reduce obstruction of downward airflow generated by the rotor blades. Similarly, when the narrow body UAV is flying forwards or backwards, the volume of area facing the wind is small. The UAV may primarily fly forwards or backwards in a direction along a longitudinal axis of the UAV. The UAV may primarily fly forwards or backwards in a direction that causes the propulsion units directly supported by the UAV to be in front and behind one another (e.g., aligned in the direction of travel). Thus, the reduced wind resistance experienced by the UAV with the narrow body may permit longer flight time of the UAV.

A narrow body UAV may experience less wind resistance than a quadcopter. The narrow body UAV may experience less wind resistance when flying in a vertical direction than a quadcopter. The narrow body UAV may experience less wind resistance when flying forwards or backwards than a quadcopter. The wind resistance experienced by the narrow body UAV may be less than the wind resistance experienced by the quadcopter per volume. The wind resistance experienced by the narrow body UAV may be less than the wind resistance experienced by the quadcopter per weight.

View B shows an example of airfoil-type effects that may be experienced by a UAV. A traditional quadcopter 300 may operate as a negative-type airfoil, which may generate downward pressure. This may cause the quadcopter to expend a greater amount of energy to remain in flight.

A narrow body UAV 310 may operate as a positive-type airfoil. This may allow generation of a lifting force that may aid in UAV flight, and reduce the amount of energy required by the UAV during flight. When performing side flight, the narrow body UAV may generate an airfoil in the positive direction, which generates a lifting force similar to a lifting body. The motor's load can be reduced and flight time may be improved. In some embodiments, depending on wind conditions, the UAV may fly forwards and backwards to reduce wind resistance. When the wind conditions are favorable to the UAV acting as an airfoil, the UAV may turn so that the UAV may perform side flight, allowing the broader side of the UAV to catch the wind. The UAV may carry one or more sensors capable of detecting when wind conditions are suitable for side flight vs. front to back flight. The UAV may carry one or more sensors capable of detecting an updraft. The UAV may carry one or more sensors capable of detecting the direction and/or strength of wind.

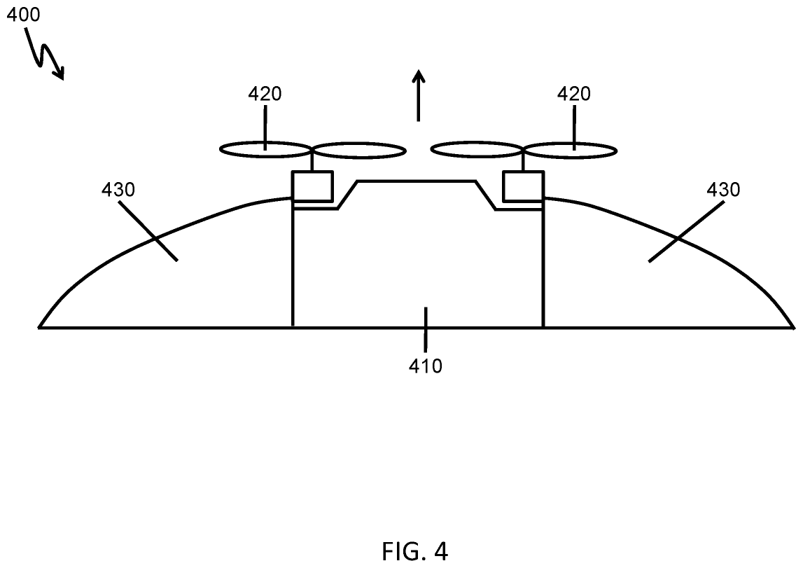

FIG. 4 shows an example of a UAV with airfoil attachments, in accordance with embodiments of the disclosure. A UAV 400 may comprise a central body 410 and one or more propulsion units 420. One or more airfoil attachments 430 may be attached to the central body.

The central body 410 may be a narrow central body. The central body may have any configuration as described elsewhere herein. The one or more propulsion units 420 may be directly coupled to the central body. The one or more propulsion units may be supported by the central body without the use of any arms extending away from the central body. In some instances, the propulsion units may be provided on a top surface of the central body. The propulsion units may comprise propellers that may rotate to generate lift for the UAV.

One or more airfoil attachments 430 may be attached to the UAV. The one or more airfoil attachments may be attached to the central body of the UAV. In some embodiments, the one or more airfoil attachments may be attached at a front end and/or back end of the central body. Optionally, two or more airfoil attachments may be provided. In one example, two airfoils may be provided at the distal ends of the central body. The airfoil attachments may be provided along a longitudinal axis of the central body. The airfoil attachments may be aligned with the propellers that are provided along a longitudinal axis of the central body. The airfoil attachments may provide an increased surface area that may utilize lift forces when the UAV is performing side flight.

The airfoil attachments may be removably attached to the UAV. For instance, a user may attach and/or detach the airfoil attachments. A user many manually attach of detach the airfoil attachments to the UAV. The airfoil attachments may be secured to the central body of the UAV, so that the airfoil attachments do not come off during flight of the UAV. In some instances, one or more locking mechanisms may be employed to attach the airfoil attachments to the UAV. In some embodiments, a user may be required to actively engage an unlocking mechanism to cause the airfoil attachments to be detached from the UAV. In some embodiments, one or more sensors of the UAV may detect when an airfoil is attached to the UAV. A UAV may enter a fixed wing flying mode when the airfoils are attached. The flight control of the UAV may utilize different sets of instructions when in fixed wing flying mode versus regular flying mode. Alternatively, there may be no sensors to detect whether the airfoil attachments are included or not. The UAV may or may not be controlled differently when the airfoil attachments are provided.

The airfoil attachments may have any shape. The airfoil attachments may have a wing shape. The airfoil shape may generate lift for the UAV as the UAV flies. In some instances, the airfoil may have a substantially curved profile. The ends of the airfoil may or may not be curved. The airfoil may or may not comprise one or more aileron. The airfoil may or may not comprise one or more wing flaps. The central body may comprise a planar surface and the one or more airfoil attachments may be substantially parallel to the planar surface. The central body may comprise a planar surface and a flying direction of the UAV may extend outwards from the planar surface. For instance, a flying direction of the UAV may be substantially to a side of the UAV. This may be due to the combined effects of rotation of the propellers and lift generated on the central body and/or airfoil attachments.

The angles of the airfoil attachments relative to the central body may be substantially fixed. For example, the surfaces of the sides of the central body may be substantially parallel to and/or follow the contour of the airfoil surfaces.

In some instances, the airfoil attachments may be movable relative to the central body. For instance, the airfoil attachments may rotate about one, two, three or more axes relative to the central body. In some embodiments, the airfoil attachments may rotate about a longitudinal axis extending along a length of the UAV. The airfoil attachments may or may not rotate about a vertical axis extending along a height of the UAV. The airfoil attachments may rotate together, or may rotate independently of one another. In some embodiments, the airfoil attachments may be rotated to provide a desired lift effect, based on an angle that the UAV is traveling at. The airfoil attachments may be rotated with aid of one or more actuators. The actuators may receive one or more commands from a flight controller. The airfoil attachments may be rotated during flight of the UAV. The airfoil attachment positions may be adjusted in real-time to provide desired effects. For instance, orientation of the one or more airfoil attachments may be adjusted during flight to generate an increased lift force from airflow.

Optionally, one or more airfoils may move relative to the central body. The airfoil attachments may rotate without aid of actuators. In some instances, the airfoils or portions thereof may be movable (e.g., rotatable) relative to the body in response to the forces of the wind experienced.

In some embodiments, when a UAV has airfoil attachments provided thereon, the UAV may function similarly to a vertical take-off and landing aircraft (VTOL). The airfoil attachments may improve lifting force and battery time. The attachments may increase the positive effect of the central body when it acts as an airfoil, which may improve lifting force and extending flight time. For instance, when the UAV is rising vertically, the airfoil attachments may provide little wind resistance or drag. When the UAV is flying sideways, the central body and the airfoil attachments may serve as airfoils, providing lift to the UAV.

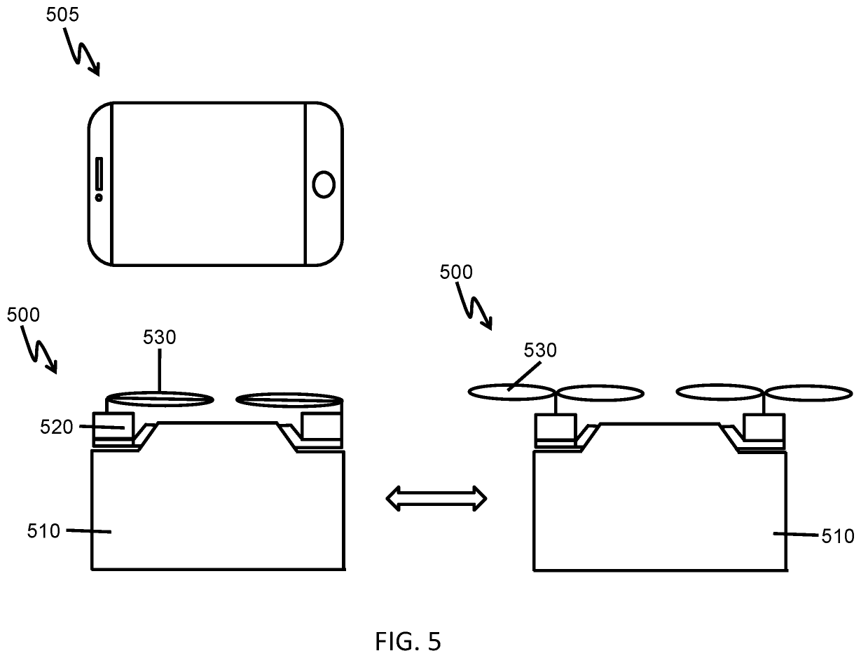

FIG. 5 shows an example of a UAV with foldable propellers, in accordance with embodiments of the disclosure. A UAV 500 may have a similar size or dimensions to a mobile device, such as a smartphone 505. In some instances, the UAV may have a similar size or dimensions to a tablet. Optionally, the UAV may have larger dimensions but similar proportions. For instance, the UAV may have similar dimensions or proportions to a laptop computer. The UAV may have a similar configuration to a cellphone that is arranged vertically on one of its sides. The central body of the UAV may be flag and its size may be similar to a mobile device. The UAV may be put into a pocket for easy storage. The UAV may provide compact storage without requiring any folding or manipulations of arms of the UAV.

The UAV may comprise a central body 510. The central body may be a narrow central body, having any of the characteristics as described elsewhere herein. The UAV may comprise one or more propulsion units. A propulsion unit may comprise a propeller seat 520 and/or one or more propeller blades 530. The propulsion units may have any arrangement relative to the central body, as described elsewhere herein. The propulsion units may or may not be rotatable relative to the central body.

A propulsion unit may comprise one or more propeller blades 530. In some instances, a propulsion unit may comprise one or more, two or more, three or more, four or more, five or more, six or more, seven or more, eight or more, ten or more, fifteen or more, or twenty or more blades. The propeller blades may or may not be detachable from the UAV. The propeller blades may or may not be detachable from a shaft of the UAV.

The propeller blades may be fixed relative to one another. The propeller blades may be fixed relative to the shaft. Alternatively, the propeller blades may be movable relative to one another. The propeller blades may be movable relative to the shaft. In some embodiments, a user may manually manipulate the propeller blades to adjust their position relative to one another. The propeller blades may be foldable. A user may manually fold the propeller blades. In some instances, a user may fold the propeller blades for easy storage. Folding propeller blades inwards, as shown on the left side of FIG. 5, provides a more compact configuration. The user may fold the propeller blades and store the UAV in the user's pocket or bag. In some instances, the propeller blades may automatically fold when the UAV has landed or when the UAV is powered off.

The propeller blades may unfold for flight of the UAV. In some instances, a user may manually unfold the propeller blades when the user is about to use the UAV for flight. In other instances, the propeller blades may unfold on their own due to centrifugal force when the shafts supporting the blades start rotating. In other instances, the propeller blades may automatically unfold with aid of one or more actuator. The propeller blades may automatically unfold when the UAV is preparing to takeoff. The foldable propeller (e.g., rotor) blades may be folded into a compact configuration when the UAV is not in use and may be in an extended configuration during flight of the UAV.

In some embodiments, a range of the propeller blades of a first propulsion unit may not overlap with a range of the propeller blades of a second propulsion unit. Thus, when the propeller blades are rotating, the areas covered within the rotation may not intersect one another. This may prevent the propeller blades from running into one another during flight of the UAV. This may prevent the propeller blades from different propulsion units from running into one another, regardless of speed or orientation of the propeller blades. The distance between the shafts of the first propulsion unit and the second propulsion unit may be greater than the length of the blades of the first propulsion unit plus the length of the blades of the second propulsion unit.

In other embodiments, a range of the propeller blades of a first propulsion unit may overlap with a range of the propeller blades of a second propulsion unit. When the propeller blades are rotating, the areas covered within the rotation may intersect one another. The rotation of the rotor blades of the first propulsion unit and the rotation of the rotor blades of the second propulsion unit may be controlled so that the rotor blades from the different propulsion units do not collide with one another. In some instances, this may require some coordination in controlling the first and second propulsion units. The distance between the shafts of the first propulsion unit and the second propulsion unit may be less than the length of the blades of the first propulsion unit plus the length of the blades of the second propulsion unit. This configuration may allow a reduced central body size for a given propeller size.

In some instances, the rotor blades may be detachable from the UAV. The rotor blades may be exchangeable with other types of rotor blades with different physical parameters.

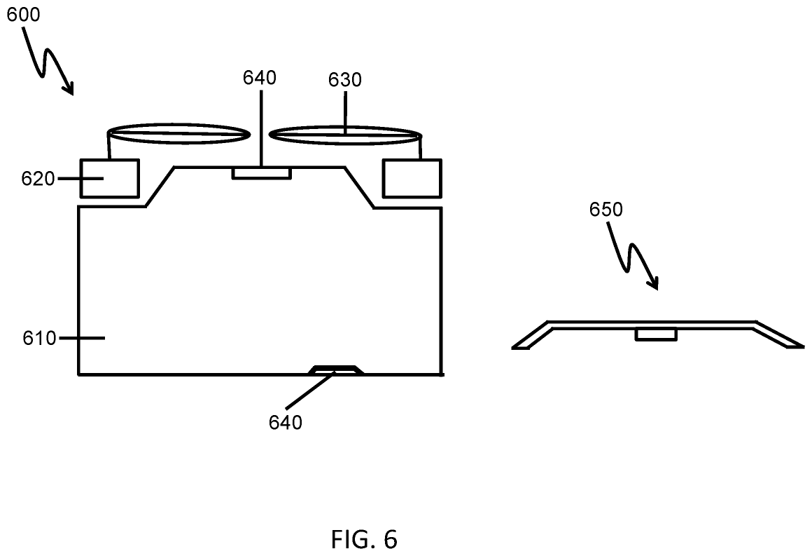

FIG. 6 shows an example of a UAV with multiple mounting sites, and an extension that can be attached or detached from the multiple mounting sites, in accordance with embodiments of the disclosure. The UAV 600 may comprise a central body 610. The central body may have any characteristics as described elsewhere herein. The UAV may comprise one or more propulsion units, which may comprise a propeller seat 620 and/or propeller blades 630. The propulsion units may have any characteristics as described elsewhere herein.

The UAV 600 may comprise one or more mounting sites 640. The one or more mounting sites may be provided on any portion of the UAV. For instance, the mounting sites may be provided on a central body of the UAV. In some embodiments, the mounting sites may be provided on a top surface and/or bottom surface of the central body. Optionally, the mounting sites may be provided on a side surface of the central body, and/or a front end or back end of the central body. The one or more mounting sites may or may not be provided on one or more propulsion units of the UAV.

In some embodiments, the UAV may have multiple mounting sites. The UAV may have two or more, three or more, four or more, five or more, six or more, eight or more, or ten or more mounting sites. The mounting sites may be provided on the same side or different sides of the UAV. In some instances, the mounting sites may be provided on opposing sides of the UAV. For instance, the mounting sites may be provided on a top surface and a bottom surface of the UAV.

Each of the mounting sites may have the same configuration. Alternatively, one or more of the mounting sites may have a different configuration. Each of the mounting sites may receive the same extension 650. Alternatively, one or more of the mounting sites may receive different extensions. The mounting site may permit mechanical connection between the UAV and the extension. In some instances, the mounting site may allow the extension to be attached to the UAV in a manner where the extension is secured to the UAV and does not come off during flight of the UAV. In some instances, the extension may be attached to the UAV in a manner where the extension does not come off the UAV without manual manipulation by the user. The extension may lock to the UAV central body. The extension may be removably attached to the UAV via the mounting site. In some embodiments the extension may be attached to the UAV (e.g., central body of the UAV) via one, two, three, or more simple motions (e.g., popping the extension onto the UAV, rotating or twisting the extension onto the UAV, depressing a button, sliding the extension into a slot or track, flipping a switch or clamp, etc.). The extension may be detached from the UAV via one, two, three, or more simple motions. The extension may be attached and/or detached from the UAV via five or fewer, four or fewer, three or fewer, two or fewer, or one or fewer simple motions. The extension may be attached and/or detached from the UAV with aid of a quick-release assembly. The user may or may not make a locking motion and/or unlocking motion when attaching and detaching the extension, respectively.

The mounting site may or may not provide electrical connection between the extension and UAV. For instance, power and/or data may flow from the UAV to the extension that is attached to the UAV. Power and/or data may or may not flow from the extension to the UAV. The mounting site may comprise one or more electrical contacts that may come into contact with one or more electrical contacts on-board the extension. This may permit the extension to have power to perform one or more actions. For example, a UAV may have an on-board power source that may provide power to the extension. Alternatively, the extension may have an on-board local power source that may or may not provide power to the UAV, or which may be used to power the extension. In some embodiments, when an extension is attached to the UAV via the mounting site, power may flow from the UAV to the extension. The UAV may recognize that an extension is attached and/or recognize the type of extension. In some instances, the extension may send identifying information to the UAV via the mounting site. When the extension receives power from the UAV, the extension may send data to the UAV about the presence of the extension and/or information about the type of extension or any other related data. In some embodiments, the UAV may comprise one or more sensors that may detect when the extension is attached to the UAV and/or recognize the type of extension attached to the UAV. When the UAV recognizes that the extension is attached and/or recognizes the type of extension, the UAV may optionally send instructions that may affect operation of the extension. Alternatively, the extension may operate independently without requiring instructions from the UAV.

In some other instances, the connection may be a purely mechanical connection and not require electrical power for the extension.

The extension may serve the same purpose regardless of which mounting site it is attached to. Alternatively, the extension may serve different purposes depending on which mounting site it is attached to. The same extension may be used for different purposes when attached to different mounting sites. In one example, the extension may function as a protective gear for the propellers when attached to a first mounting site, and the extension may serve as a landing stand when attached to a second mounting site, as described in greater detail below. In alternative embodiments, different extensions may be attached to different mounting sites or the same mounting site for different purposes.

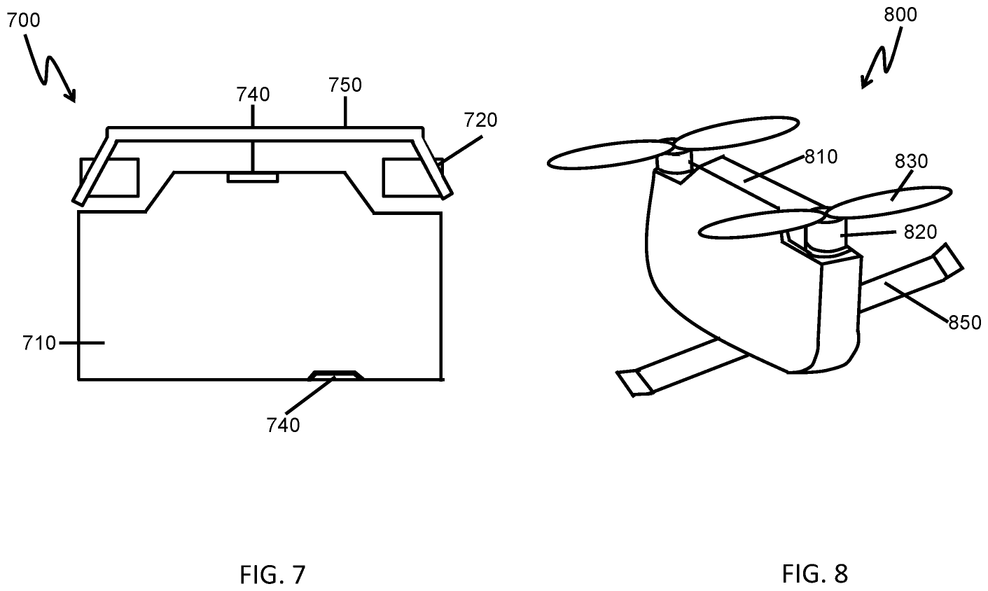

FIG. 7 shows an example of how an extension can be attached to a UAV as protective gear, in accordance with embodiments of the disclosure. The UAV 700 may comprise a central body 710. The central body may have any characteristics as described elsewhere herein. The UAV may comprise one or more propulsion units, which may comprise a propeller seat 720 and/or propeller blades 730. The propulsion units may have any characteristics as described elsewhere herein. One or more mounting sites 740 may be provided. The mounting sites may have any characteristics as described elsewhere herein.

An extension 750 may be attached to a mounting site 740. In one example, the extension may be attached to a mounting site on a top surface of the UAV. The extension may be attached to a mounting site on an upper surface of a central body of the UAV. The top portion of the central body may be configured to receive the extension. The extension may be provided on a same side of the UAV as a side on which the propulsion units are arranged.

The extension may serve a protective gear for the propellers of the UAV when attached to a mounting site. The extension may be configured to hold the propeller blades in place. The extension may be configured to protect the propeller blades. The extension may serve as protective gear when the UAV is not in flight. The extension may serve as protective gear when the UAV is being transported or stored. The propeller blades of the UAV may be folded inward when the extension is attached as the protective gear. The folding in of the propeller blades may provide a compact arrangement for the UAV, and the protective gear may protect the folded propeller blades. The protective gear may optionally prevent the folded propeller blades from swinging outward while the protective gear is attached. The protective gear may protect the propeller blades from damage (e.g., bending) when the protective gear is attached. Even if the UAV is dropped, the protective gear may prevent the blades from coming into the contact with the ground or other surface and protect them from damage. Similarly, if the UAV is transported, it may prevent the propellers from bumping into items and being damaged. The protective gear may optionally cover at least a portion of the top surface of the propeller blades when the protective gear is attached. The protective gear may cover an entirety of the top surface of the propeller blades. The protective gear may or may not cover hubs of the propellers of the UAV. The protective gear may serve as compact protective covers for the propellers. The protective gear may be attached as needed and may be detached when no longer needed (e.g., when the UAV is in flight).

The protective gear may have a length that may extend substantially along the length of the UAV. The protective gear length may be about the same as a length of the central body of the UAV. The protective gear length may be plus or minus about less than or equal to 10%, 7%, 5%, 3%, 2%, 1%, 0.5% or 0.1% the length of the UAV central body. The protective gear may or may not comprise bends at the end of the protective gear. For instance, the protective gear may have ends that slant inwards toward the central body. This may provide a more compact shape and/or reduce sharp edges or corners. The ends may be slanted or curved.

The extension serving as the protective gear may be removed from the UAV when the UAV is ready for flight. Prior to takeoff of the UAV, a user may remove the extension from the UAV. The user may or may not put the extension on another portion of the UAV. In some embodiments, a sensor may be provided that may detect the presence or absence of the extension from the mounting site where it would serve as protective gear. In some embodiments, if the extension is still attached as the protective gear, the UAV may be prevented from taking off. If a sensor detects that the extension is still attached as the protective gear, the UAV may be prevented from taking off. For instance, the motors controlling the propellers may be prevented from spinning. When the extension has been removed from the mounting site where it would function as the protective gear, the UAV may be permitted to take-off.

FIG. 8 shows an example of how an extension can be attached to a UAV as a landing stand, in accordance with embodiments of the disclosure. The extension 750 may be attached to a mounting site 740 to serve as a landing stand. In one example, the extension may be attached to a mounting site on a bottom surface of the UAV. The extension may be attached to a mounting site on a lower surface of a central body of the UAV. The bottom portion of the central body may be configured to receive the extension. The extension may be provided on a different side of the UAV as a side on which the propulsion units are arranged. The extension may be provided on a same side of the UAV configured to face a landing surface when the UAV is landing or taking off from the surface.

The extension may serve a landing stand for the UAV when attached to a mounting site. The extension may be configured to support the UAV when the UAV is landed. The extension may be configured to bear weight of the UAV when the UAV is resting on an underlying surface. The extension may serve as a landing stand when the UAV is not in flight. The extension may serve as landing gear when the UAV is resting on a surface. The extension may be attached to the UAV as a landing gear when the UAV is in flight. When the UAV is in flight, the landing stand may not be bearing weight of the UAV on an underlying surface. The configuration of the landing stand may be the same when the UAV is in flight and when the UAV is landed. Alternatively, the configuration of the landing stand may be different when the UAV is in flight and when the UAV is landed.

The extension may have a length that may extend substantially along the length of the UAV. The extension length may be about the same as a length of the central body of the UAV. The protective gear length may be plus or minus about less than or equal to 10%, 7%, 5%, 3%, 2%, 1%, 0.5% or 0.1% the length of the UAV central body. The extension length may be oriented differently from the length of the central body. In some instances, the extension length may be perpendicular to the length of the central body when attached as a landing stand. The extension may be arranged so that it extends in a lateral direction. The landing stand may protrude from the sides of the UAV to provide stability to the UAV. The protective gear may or may not comprise bends at the end of the protective gear. For instance, the protective gear may have ends that slant upwards toward the central body when attached as the landing stand. This may provide a more compact shape and/or reduce sharp edges or corners. The ends may be slanted or curved.

The extension serving as the landing stand may be removed from the UAV when the UAV is stored or transported. The extension may then be used as protective gear for the UAV. Prior to takeoff of the UAV, a user may attach the extension to the UAV. In some embodiments, a sensor may be provided that may detect the presence or absence of the extension from the mounting site where it would serve as a landing stand. In some embodiments, if the extension is not attached as the landing stand, the UAV may be prevented from taking off. If a sensor detects that the extension is not attached as the landing stand, the UAV may be prevented from taking off. For instance, the motors controlling the propellers may be prevented from spinning. Alternatively, the UAV may be permitted to take off regardless of whether the landing stand is attached. In some embodiments, the landing stand may be used when the UAV is landing on an underlying surface and is not used when landing on a user's hand. In some embodiments, not including the landing stand at all may provide a reduced weight for the UAV, which may increase flight time. The user may determine when it is convenient to attach the extension as a landing stand.

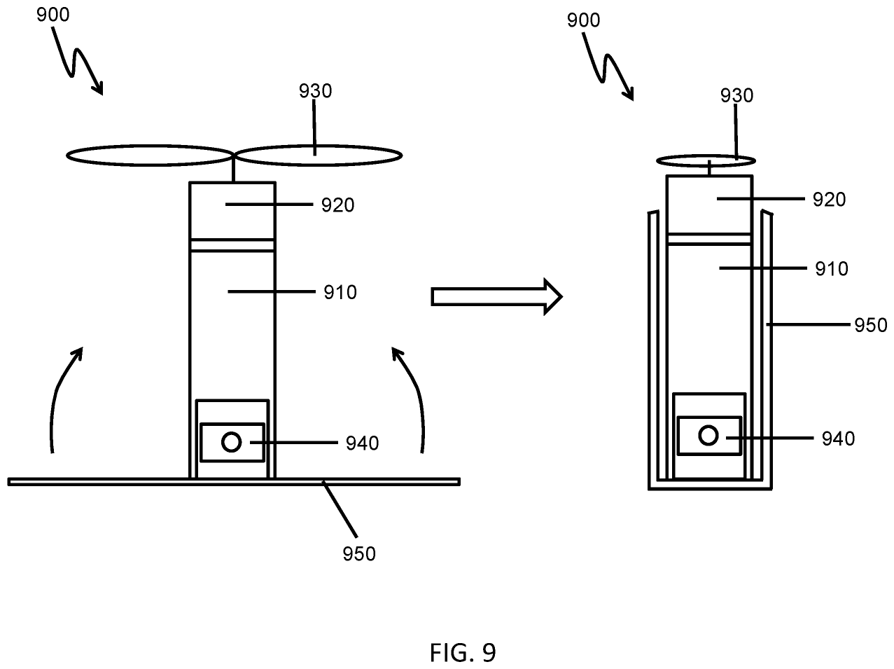

FIG. 9 shows an example of a foldable landing stand, in accordance with embodiments of the disclosure. The UAV 900 may comprise a central body 910. The central body may have any characteristics as described elsewhere herein. The UAV may comprise one or more propulsion units, which may comprise a propeller seat 920 and/or propeller blades 930. The propulsion units may have any characteristics as described elsewhere herein.

The UAV may comprise a camera module 940. The camera module may be provided on-board a central body of the UAV. The camera module may be integrated into the central body of the UAV, permanently attached to the central body, or may be removably attached to the central body. The camera module may comprise a payload, such as a camera, or any other type of payload as described elsewhere herein. The camera module may comprise a carrier, such as a gimbal, as described elsewhere herein. The gimbal may be a one-axis gimbal, two-axis gimbal, or three-axis gimbal. The payload may be supported by the carrier. The carrier may be used to control the orientation of the payload relative to the central body. For instance, the carrier may be used to control the orientation of a camera relative to the central body.

The UAV may comprise a landing stand 950. The landing stand may be configured to support the UAV when the UAV is not in flight. The landing stand may be configured to bear weight of the UAV when the UAV is landed on a surface. The landing stand may be an extension that is attached to a mounting site of the UAV. The landing stand may have any characteristics of an extension functioning as a landing stand, as described elsewhere herein. The landing stand may be detachably coupled to the UAV. The landing stand may or may not have another function when attached to a different portion of the UAV. In other instances, the landing stand may be permanently attached to the UAV.

The landing stand may come into contact with an underlying surface when the UAV is not in flight. The landing stand may or may not permit the central body of the UAV to come into contact with the underlying surface when the UAV is resting on the surface. In some instances, the landing stand may cause the central body to be at least partially elevated over the underlying surface. The landing stand may or may not prevent a camera module from coming into contact with the underlying surface when the UAV is resting on the surface. The landing stand may cause the camera module to be at least partially elevated over the underlying surface. This may reduce the likelihood that the camera is damaged when the UAV takes off or lands on the underlying surface.

The landing stand may be substantially static. The landing stand may be static relative to a central body of the UAV. Alternatively the landing stand may have one or more movable components. The one or more movable components may be movable relative to a central body of the UAV. The landing stand itself may be movable relative to the central body of the UAV. In one example, the landing stand may be a foldable landing stand. The landing stand may include one or more lateral extensions that may provide stability to the UAV when the UAV is resting on a surface. The lateral extensions may extend perpendicularly relative to a longitudinal axis of the UAV. The lateral extensions may be foldable. The lateral extensions may fold upwards toward the central body of the UAV. The lateral extensions may fold upwards until they have a substantially vertical orientation. The lateral extensions may fold upwards until they come into contact with the sides of the central body. The lateral extensions may fold upwards until they are flush against the sides of the central body. The lateral extensions may fold up and fold back out to their lateral configuration.

Optionally, the lateral extensions may be folded outwards when the UAV is resting on a surface, about to land on a surface, or immediately after taking off from a surface. The lateral extensions may be folded upwards when the UAV is in flight, or when the UAV is being stored or transported. Folding the lateral extensions upwards may provide a more compact form of the UAV. The compact form of the UAV may allow for reduced space requirements for storage or transport. The compact form of the UAV may provide improved aerodynamics during flight of the UAV compared to having the extensions folded outward. The lateral extensions may be locked into their respective positions at the various stages of use. For example, when the extensions are folded outward, they may remain in the outward position until manually manipulated by a user, or in response to a command or movement by an actuator. When the extensions are folded upwards, they may remain in the upward position until manually manipulated by a user, or in response to a command or movement by an actuator. In some instances, the lateral extensions may remain upwards during flight of the UAV without coming down until the UAV is ready to land.

In some embodiments, the lateral extensions may be folded substantially outwards when in a landing stand configuration. The lateral extensions may be folded outwards to be substantially perpendicular to a side surface of the central body. The lateral extensions may form a substantially straight line relative to one another. The lateral extensions may be substantially parallel to one another when folded outwards. In some embodiments, the lateral extensions may be folded at least partially downwards when in a landing stand configuration. The lateral extensions may be folded at least partially downwards to create an obtuse angle between the lateral extension and a side of the central body. In some instances two lateral extensions may be provided. In some instances, additional lateral extensions may be provided. For instance, a landing stand may have a tripod configuration.

The lateral extensions may change position in response to manual manipulation by a user. In some instances, the user may directly pull on the lateral extensions to get them to change angle to a desired position. The user may or may not unlock the lateral extensions from a given position with an additional action, such as motions described elsewhere herein. Alternatively or in addition, the lateral extensions may automatically change positions in response to a command without requiring manual manipulation by a user. One or more actuator may effect movement of the lateral extensions in response to a command. The command may be generated by a flight controller or any other processors on-board the UAV. The command may be generated in response to data collected by a sensor. For instance, if the UAV is approaching a landing surface, the landing stand extensions may automatically fold outwards. If the UAV has taken off and is in flight, the landing stand extensions may automatically fold upwards. The extensions folding upwards and downwards may comprise at least a portion of the extension being rotatable relative to the central body.

In some embodiments, an extension attached to a UAV may be configured to be rotatable relative to the central body when attached to the central body. All or a portion of the extension may be rotatable relative to the central body. The extension may be configured to be rotatable relative to the central body when attached to a top surface or a bottom surface of the central body, or any other side, end, or portion of the central body. The extension may be manually rotatable. For instance, a user may directly manually manipulate the extension to cause rotation of the extension. The extension may be automatically rotatable with aid of one or more actuators. The extension may be configured to rotate in response to a sensed condition. In one example, the extension may be rotated to have a length extending perpendicular to a longitudinal axis of the central body when the UAV is about to land and rotated to have a length extending parallel to the longitudinal axis when the UAV is in flight. The extension may rotate about a vertical axis. The extension may rotate about a vertical axis to change orientation of the extension.

The UAV may be held in a user's hand when not in flight, or may rest on a surface when not in flight. The camera module may permit the UAV to capture images while in flight and while not in flight. For instance, the UAV may be capable of aerial photography with aid of camera module when in flight. The UAV may be captured of ground-based photography with aid of the camera module when not in flight. When the UAV is held in a user's hand, the UAV may be used for handheld photography. When the UAV is resting on a surface, the UAV may be used for land-based photography with the extension serving as the support.

The extension may or may not be configured to protect a camera module of the UAV. For instance, the extension may be configured to protect a payload and/or a carrier configured to control orientation of the payload relative to the central body. The payload may be an image capture device. The extension may prevent the camera module from coming into contact with an underlying surface when the UAV is resting on the surface. The extension may provide protection for the camera module while the UAV is in flight. The extension may at least partially surround or cover the camera module when the UAV is flight, or when the UAV is landing on a surface.

An extension, such as a landing gear, may have a variety of configuration, such as those illustrated herein, and variations thereof. For instance, the landing gear may pull out, rotate out, push out, or be extended beyond the central body. The landing gear may extend longitudinally and/or along a direction of the width of the UAV. The landing gear may or may not have vertical components upwards and/or downwards. The landing gear may fold or pivot about one or more locations. The landing gear may rotate about one or more axes (e.g., vertical axis, longitudinal axis, and/or width axis). The landing gear may cover and protect the camera. The landing gear may cover and protect the camera when retracting or when extending. The landing gear may protect the camera when retracted.

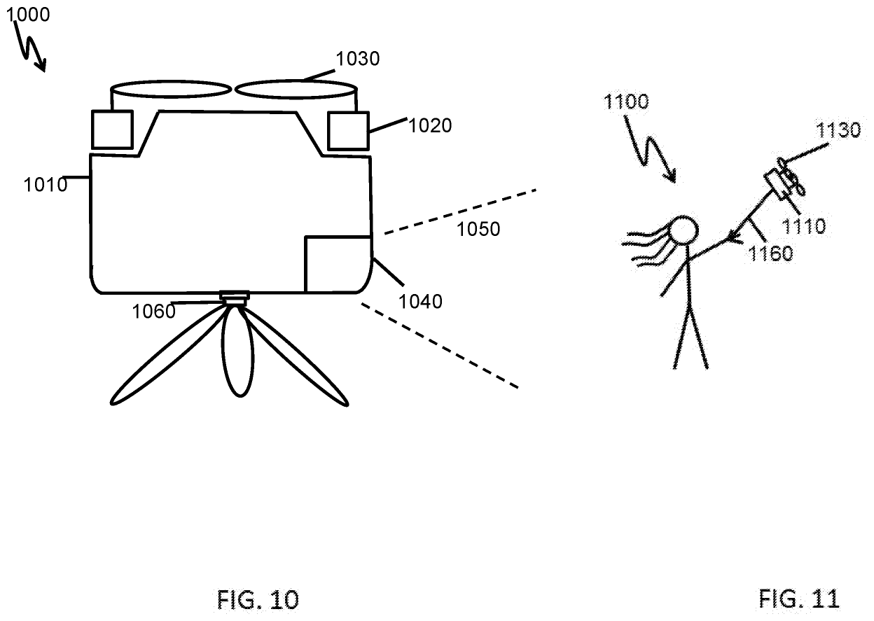

FIG. 10 shows an example of an extension that can be attached to the UAV as a tripod, in accordance with embodiments of the disclosure. The UAV 1000 may comprise a central body 1010. The central body may have any characteristics as described elsewhere herein. The UAV may comprise one or more propulsion units, which may comprise a propeller seat 1020 and/or propeller blades 1030. The propulsion units may have any characteristics as described elsewhere herein. The UAV may comprise a camera module 1040. The camera module may have any characteristics as described elsewhere herein. The camera module may be capable of capturing an image within a field of view 1050.

In some embodiments, the extension may be a tripod 1060. The extension may have any characteristics as described elsewhere herein. The extension may be detachably mounted to a mounting site of the UAV. The tripod may comprise any number of supporting legs. In some embodiments, any description herein of a tripod may apply to a monopod. For instance, a single supporting leg may be provided which may be configured to bear weight of the UAV when the UAV is not in flight. The single supporting leg may have an extended base or may be reconfigurable to accommodate different support situations. For example, the single supporting leg may be bendable. In other instances, the tripod may comprise two legs, three legs, four legs, five legs, six legs, seven legs, eight legs, or more. The legs may be substantially static or may be substantially movable. In some instances, the legs may be bendable. The legs may bend at one or more joints. The entirety of the length of the leg may be bendable. The legs may wrap around one or more object. The legs may move relative to a central hub. The central hub may connect to a mounting site of the UAV. The legs may extend outward from a hub. The legs may pivot relative to the hub. The legs may be adjusted when the UAV lands to provide a desired effect.

The UAV may be used for land-based photography when the UAV is resting on the tripod when the UAV is not in flight. The tripod may be support the UAV on a stationary or moving surface. For instance, the tripod may support the UAV on a static surface. The legs of the tripod may be arranged to provide stable support for the UAV. The legs may contact the underlying surface. In some instances, the legs may wrap around one or more objects. The UAV may be capturing images while resting on the static surface. The UAV may be attached to a moving surface, such as a vehicle or a boom. The tripod may include legs that may lock into the moving surface, be clamped by the moving surface, or wrap around or more portions of the moving surface. The tripod may be held by a user's hand. The user may grasp one or more legs of the tripod to use the UAV for handheld photography.

The tripod may be exchanged for any other type of landing stand extension as described elsewhere herein. For instance, in some embodiments, a landing stand that may also function as a propeller protective gear may be exchanged for a tripod landing stand. Different types of landing stands may be attached and/or detached from a mounting site of the UAV.

FIG. 11 shows an example of an extension that can be attached to the UAV as a selfie stick, in accordance with embodiments of the disclosure. The UAV 1100 may comprise a central body 1110. The central body may have any characteristics as described elsewhere herein. The UAV may comprise one or more propulsion units, which may comprise a propeller seat and/or propeller blades 1130. The propulsion units may have any characteristics as described elsewhere herein. The UAV may comprise a camera module. The camera module may have any characteristics as described elsewhere herein. The camera module may be capable of capturing an image within a field of view.

In some embodiments, the extension may be a selfie stick 1160. The extension may have any characteristics as described elsewhere herein. The extension may be detachably mounted to a mounting site of the UAV. The selfie stick may comprise a handle that the user may grip when holding the selfie stick. The selfie stick may include an extended body that may hold the UAV away from the user. The extended body may have an adjustable length. For instance, the extended body may have two or more components that may slide relative to one another to adjust the length of the extended body. In one example, the components of the extended body may have a telescoping configuration. The telescoping pieces may slide relative to one another to permit extension and compaction of the selfie stick. The selfie stick may comprise one or more components that are rigid. Alternatively, one or more components may be bendable or flexible.

The handle of the selfie stick may comprise one or more controls. The user may interact with the controls while holding the selfie stick. The user may interact with the controls while the UAV is supported on the selfie stick and held away from the user. In some instances, the controls may permit a user to capture a photo of the user with aid of a camera on-board the UAV. The controls may provide instructions to snap a photo, zoom in and/or zoom out, switch a viewing modality, switch an image capture modality, and/or adjusting an angle of the camera relative to the UAV body. The controls may affect operation of a carrier of a payload. For instance, the controls may cause a gimbal to control orientation of a camera relative to the central body.

A selfie stick may be mechanically connected to the UAV. The selfie stick may lock to the UAV at a mounting site or any other connection mechanism. The UAV may remain attached to the selfie stick, even when propellers of the UAV are rotating. The UAV may be removed from the selfie stick through manual manipulation by the user. In some instances, the UAV may be removed from the selfie stick only when the user removes the UAV from the selfie stick. The user may engage in one or more motions to remove the UAV from the selfie stick, as described elsewhere herein. The selfie stick may be electrically connected to the UAV. Power and/or communications from flow from the stick to the UAV, and/or from the UAV to the stick. In one example, input by a user via the controls of the selfie stick may affect operation of the UAV (e.g., operation of a camera module, operation of one or more propellers, operation of one or more light sources, operation of one or more audio sources, etc.). The selfie stick may comprise one or more electrical contacts which may come into contact with one or more electrical contacts of a mounting site of the UAV. The power and/or communications may flow via the one or more electrical contacts. In some instances, a power source may be on-board the UAV and may provide power to the selfie stick. In other instances, a power source may be on-board the selfie stick and may provide power to one or more components of the UAV. IN some instances, both the UAV and the selfie stick may have their own power source.

A user may hold the selfie stick while the camera on-board the UAV captures images of the user. The camera on-board the UAV may be configured to be automatically controlled to focus on a user holding the selfie stick. The images captured by the camera may be analyzed to recognize the user. The individual user may be recognized, or the user may be recognized as having a human face that the camera will focus on. The camera may be controlled to focus on the user and/or other individuals around the user within the field of view.

In some instances, the propellers of the UAV may rotate to direct airflow toward the user to create a wind effect. The propeller blades may be oriented to direct airflow towards the user. In some embodiments, the UAV may recognize when the selfie stick is attached to the UAV. The propellers may rotate at a desired speed to provide the wind effect. In some instances, attachment of the selfie stick may be recognized by the UAV and may automatically cause the propellers to rotate at a desired rate. Optionally, the selfie stick may comprise one or more controls that may allow the user to control the wind effect by the propellers. The controls may be provided on a handle of the selfie stick so that the user may be able to manipulate the controls while the UAV is attached to the selfie stick. For instance, the user may be able to turn the wind effect on or off (control whether the propellers rotate or do not rotate). The user may or may not be able to adjust a level of the wind effect. For instance, the controls may permit the user to adjust the speed at which the propellers may rotate, which may affect the degree of wind blown towards the user. The user can provide an input to increase or decrease the speed at which the propellers are rotating. In some instances, a maximum limit may be provided to the speed at which the propellers are rotating while the selfie stick is attached to the UAV.

The UAV may comprise one or more light sources. The light source may be used to provide illumination of the user holding the selfie stick. The light source may be primarily directed toward the user holding the selfie stick. In some instances, a single light source may be provided. Alternatively, multiple light sources may be provided. The light sources may be of different characteristics. For example, the light sources may emit lights of different colors. The user may select one or more of the light sources to provide light to achieve a desired lighting effect in the photo. For instance, the user may select a light source with a particular color of light, or a combination of light sources of various colors of light to provide a desired lighting effect. In some instances, the angle of the light may be adjustable. The brightness of the light sources may be adjustable. Brightness levels of multiple light sources may be adjusted independently of one another. Optionally, the selfie stick may comprise one or more controls that may allow the user to control the lighting effect. The controls may be provided on a handle of the selfie stick so that the user may be able to manipulate the controls while the UAV is attached to the selfie stick. For instance, the user may be able to turn one or more light sources on or off. When multiple light sources are available, a user may independently turn each of the light sources on or off. If the light sources are of different colors, the user may thus be controlling the overall color of light being emitted by the UAV. The user may or may not be able to adjust a brightness level of the light sources. The user can provide an input to increase or decrease the brightness at which each of the light sources are emitting light.

The UAV may be used for land-based photography when the UAV is attached to the selfie stick when the UAV is not in flight. The selfie stick may be held by a user's hand. The selfie stick may be removed when the UAV is in flight. The UAV may or may not be capable of flight when the selfie stick is attached.

The selfie stick may be exchanged for any other type of landing stand extension as described elsewhere herein. For instance, in some embodiments, a landing stand that may also function as a propeller protective gear, or a tripod, may be exchanged for a selfie stick. Different types of landing stands may be attached and/or detached from a mounting site of the UAV.

The UAV may be a portable device that may be well suited for aerial photography and for taking selfies or other types of handheld photography. Features of the UAV that may be used for flight, may also aid in the taking of selfies or other types of handheld photography. For instance, the propellers may advantageously be useful for flight of the UAV and for providing wind effects when taking a selfie.

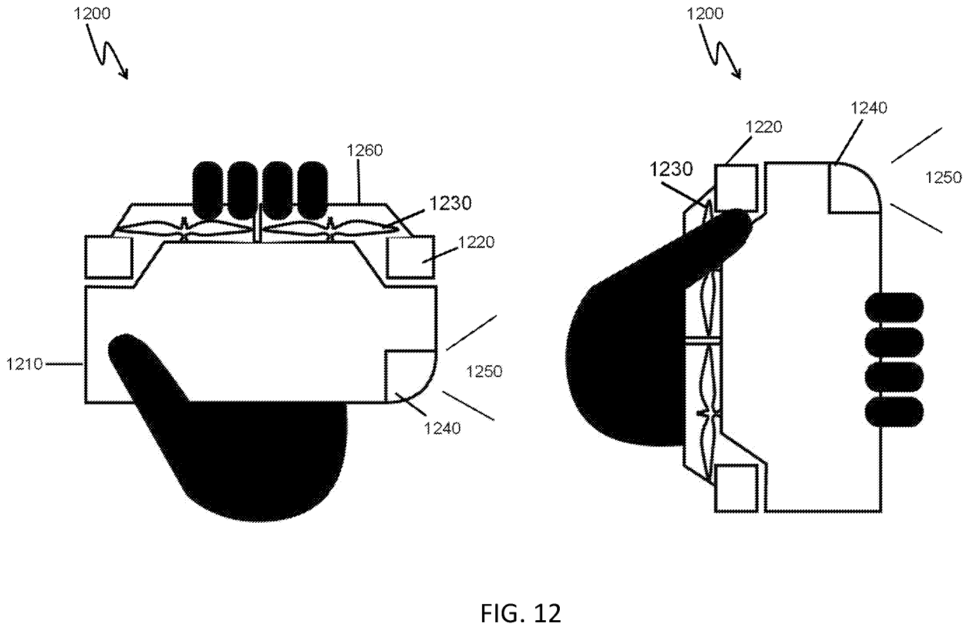

FIG. 12 shows multiple ways in which the UAV can be held, in accordance with embodiments of the disclosure. The UAV 1200 may comprise a central body 1210. The central body may have any characteristics as described elsewhere herein. The UAV may comprise one or more propulsion units, which may comprise a propeller seat 1220 and/or propeller blades 1230. The propulsion units may have any characteristics as described elsewhere herein. The UAV may comprise a camera module 1240. The camera module may have any characteristics as described elsewhere herein. The camera module may be capable of capturing an image within a field of view 1250. Optionally, an extension may or may not be attached to the UAV. For instance, an extension serving as a propeller guard 1260 may be attached to the UAV.

The UAV may be configured to be held in a user's hand. In one example, a UAV may be held in a substantially horizontal orientation with the propellers facing upwards. When in the substantially horizontal orientation, a user's fingers may wrap over the propellers. The propellers may be folded inwards to provide a compact shape. A propeller guard may or may not be provided to protect the propellers. A camera module may be provided on-board the UAV. A camera of the camera module may capture images while the UAV is held in the user's hand. The UAV may be used for handheld photography. The field of view of the camera may be adjustable relative to the UAV central body. The camera module may comprise a carrier that may allow the camera orientation relative to the UAV body to change. In some instances, the field of view may be directed substantially horizontally. When the field of view is directed substantially horizontally, it may be directed toward an end of the UAV body.

In another example, a UAV may be held in a substantially vertical orientation with the propellers facing toward the side. When in the substantially vertical orientation, a user's thumb may be supported over the propellers. The propellers may be folded inwards to provide a compact shape. A propeller guard may or may not be provided to protect the propellers. A camera module may be provided on-board the UAV. A camera of the camera module may capture images while the UAV is held in the user's hand. The UAV may be used for handheld photography. The field of view of the camera may be adjustable relative to the UAV central body. The camera module may comprise a carrier that may allow the camera orientation relative to the UAV body to change. In some instances, the field of view may be directed substantially horizontally. When the field of view is directed substantially horizontally, it may be directed toward a bottom of the UAV body.

In some instances, the UAV orientation relative to an inertial reference frame may change. For instance, a user may switch between horizontal and vertical orientations, or any other orientation. The camera may remain stabilized on the UAV. For instance, the field of view of the camera may remain pointing in substantially the same direction, regardless of how the orientation of the UAV central body may change. The camera may be stabilized with aid of the carrier (e.g., gimbal). For instance, if the field of view is directed in a substantially horizontal direction, it may remain facing in the same substantially horizontal direction despite movement of the UAV central body. The direction of the field of view of the camera may be controlled independently of the orientation of the UAV central body. In some instances, the user may actively control the field of view of the camera to aim in a desired direction. The field of view of the camera may remain pointing in the desired direction regardless of motion of the UAV body.

The UAV may comprise one or more sensors that may be able to detect the orientation of the UAV relative to an inertial reference frame. The one or more sensors may be able to detect the orientation of the UAV relative to a direction of gravity. The sensors may be able to detect an attitude of the UAV, a rotational speed of the UAV, a rotational acceleration of the UAV, a location of the UAV, a linear speed of the UAV, and/or a linear acceleration of the UAV. In some embodiments, the sensors may comprise one or more inertial sensors, such as accelerometers, gyroscopes, magnetometers, or any other types of inertial sensors. The data from the sensors may be useful in stabilizing the camera.

The UAV may function as a mini handheld stabilizer for the camera. The carrier on-board the UAV may allow the UAV to function as the handheld stabilizer for the camera. The UAV may be well suited for ground-level photography (e.g., handheld photography).

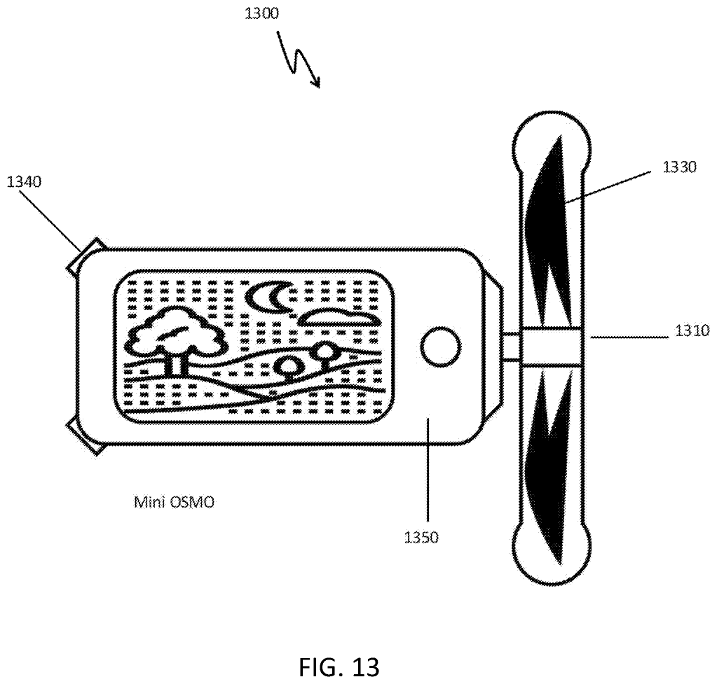

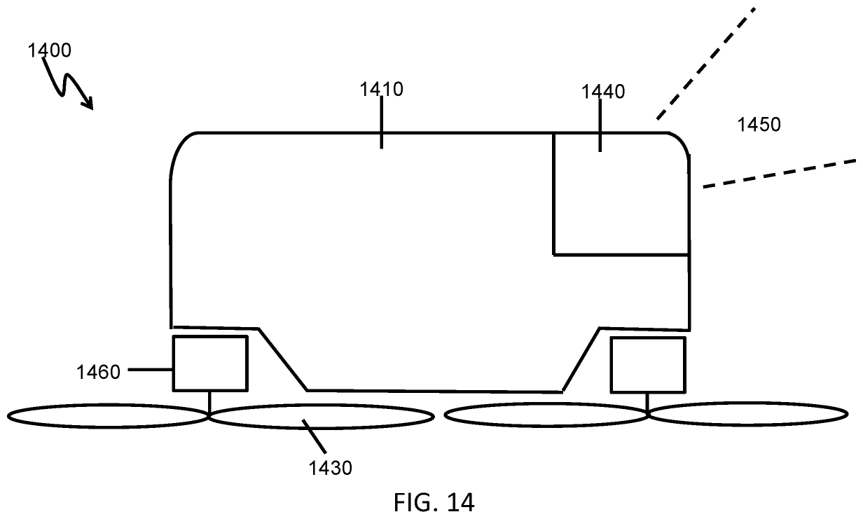

FIG. 13 shows a handheld sling and phone holder, in accordance with embodiments of the disclosure. A UAV 1300 may comprise a central body 1310. The central body may have any characteristics as described elsewhere herein. The UAV may comprise one or more propulsion units, which may comprise a propeller seat and/or propeller blades 1330. The propulsion units may have any characteristics as described elsewhere herein.

An extension such as a handheld sling 1340 may be attached to the UAV. The extension may be attached to a mounting site of the UAV. For instance, the extension may be attached to a mounting site on a top surface or bottom surface of the UAV. Any description elsewhere herein regarding extensions may apply.

The handheld sling may extend to a side of the UAV. For instance, the handheld sling may extend to a right side or left side of the UAV. The handheld sling may be configured to accept a mobile device 1350, such as a smartphone. The mobile device may snap into or out of the handheld sling. The mobile device may comprise a display. The display may be a touchscreen display or any other type of display capable of showing information. The display may comprise a graphical user interface. The display may show an image captured by a camera on-board the UAV. The display may show a streaming image from the camera on-board the UAV. The display may show images captured by the camera on-board the UAV in substantially real-time (e.g., within 1 minute, 45 seconds, 30 seconds, 20 seconds, 15 seconds, 10 seconds, 7 seconds, 5 seconds, 3 seconds, 2 seconds, 1 second, 0.5 seconds, 0.1 seconds, 0.05 seconds, 0.01 seconds, 0.005 seconds, or 0.001 seconds of the image being captured by the camera).

In some embodiments, data from the camera may be provided to the mobile device via a wireless connection. The mobile device may be capable of displaying the images captured by the camera even when the mobile device is not attached to the handheld sling, or the handheld sling is not attached to the UAV. In some instances, a direct wireless connection may be provided between the mobile device and the camera. In other embodiments, data from the camera may be provided to the mobile device via a wired connection. The mobile device may only display the images captured by the camera when the mobile device is attached to the handheld sling and when the handheld sling is attached to the UAV. The camera may provide data about the images via an electrical connection between the UAV and the handheld sling via the mounting site, and the handheld sling may further convey the data via an electrical connection between the mobile device and the handheld sling.

The mobile device may be useful for framing images captured by the camera. By viewing the images on the mobile device, a user may be able to adjust the orientation of the UAV and/or camera. The camera may be stabilized so that even if the UAV is moved around, the camera is pointing in substantially the same direction. When the UAV is carried or worn by a user, or mounted on a movable object (e.g., bicycle, car, boat, motorcycle, or any other type of vehicle), the UAV may serve as a self-stabilization motion camera.

Any description herein of a handheld sling may also apply to a wearable. For instance, an extension may be a wearable object that may permit the UAV to be worn on a user's body. For instance, the UAV may be worn around a user's wrist, arm, neck, leg, head, torso, or any other art of the user's body. The UAV may be attached to a wearable that may be a helmet, hat, headband, glasses, pendant, chest strap, arm strap, watch, leg strap, jacket, shirt, pants, or any other wearable object.

FIG. 14 shows an example of a UAV in a reverse flying mode, in accordance with embodiments of the disclosure. The UAV 1400 may comprise a central body 1410. The central body may have any characteristics as described elsewhere herein. The UAV may comprise one or more propulsion units, which may comprise a propeller seat 1420 and/or propeller blades 1430. The propulsion units may have any characteristics as described elsewhere herein. The UAV may comprise a camera module 1440. The camera module may have any characteristics as described elsewhere herein. The camera module may be capable of capturing an image within a field of view 1450.

In some embodiments, a UAV may be capable of flying in a right-side up mode and an upside-down mode. In some embodiments, a UAV may have propellers that are provided on a top side of the UAV when the UAV is flying in a right-side up mode. The propellers may be on a bottom side of the UAV when the UAV is flying in an upside-down mode. The propellers may be located above a camera during a first flight mode (e.g., right-side up mode). The propellers may be located beneath the camera during a second flight mode (e.g., upside-down mode). In some embodiments, the fight flight mode may be a downward aerial photography flight mode and the second flight mode may be an upward aerial photography flight mode. For instance, the camera may be on a lower part of the central body during the first flight mode, and may be oriented at least partially downward, or horizontally. The camera may be an upper part of the central body during the second flight mode, and may be oriented at least partially upward, or horizontally. As illustrated, when the camera is flying in an upside-down mode the carrier and camera can freely capture images in an upwards direction. The orientation of the central body may change between the first flight mode and the second flight mode. The central body may flip between the first flight mode and the second flight mode.

In some embodiments, the UAV may fly in a right-side up mode for a duration of the flight. Then the user may make an adjustment such as flipping the UAV over. The UAV may then fly in an upside-down mode for a duration of the flight. In other embodiments, the UAV may switch between flying in a right-side up mode and an upside-down mode while in flight. In some instances, the UAV may switch between the flight modes by adjusting an orientation of the one or more propellers relative to the central body. In some instances, the UAV may switch between flight modes by adjusting a speed of rotation of one or more propellers.

The same rotor blades may be used for the first flight mode and the second flight mode. Alternatively, different rotor blades may be used for the first flight mode and the second flight mode. In some embodiments, the rotor blades used in the second flight mode may have a reverse direction of pitch as rotor blades in the first flight mode. The rotor blades may have the exact reversed pitch, or may have different pitches. The other characteristics between the sets of rotor blades may or may not be the same (e.g., length, width, shape, thickness, pitch, cross-section, materials). In some embodiments, rotor blades for right-side up flying may be different from rotor blades for upside-down flying. Specialized rotor blades may be configured for upside-down flying. In some embodiments, the control logic for controlling rotation of the propellers may be different between the first flight mode and the second flight mode. The control logic may take into account that the relative positioning between the propellers and the central body has changed. The control logic may take into account that a center of mass of the UAV is at a different position relative to the propellers between the first flight mode and the second flight mode. The propellers may be rotating in the same direction between the first flight mode and the second flight mode. Alternatively the propellers may be rotating in a different direction between the first flight mode and the second flight mode.

In some embodiments, propellers may be located both above and below a central body. In some instances, only the propellers above the body may be rotating during a first flight mode and only the propellers below the central body may be rotating during a second flight mode. Alternatively, both sets of propellers may be in operation during a first flight mode and/or second flight mode. The UAV central body need not change orientations between the first flight mode and the second flight mode. In some instances, propellers located beneath the central body may have a similar configuration to the propellers located above the central body. The propellers beneath the central body may be located at or near distal ends of the central body. The propellers beneath the central body may be arranged along a longitudinal axis of the central body. The propellers beneath the central body may comprise a pair of propellers. A corresponding pair of motors may drive the pair of propellers. The orientation of the propellers beneath the central body relative to the central body may be static, or may be adjustable. The orientation of the pair of propellers beneath the central body may be adjusted with aid of one or more actuators, such as servomotors. The orientation of the pair of propellers beneath the central body may be adjusted about a longitudinal axis.

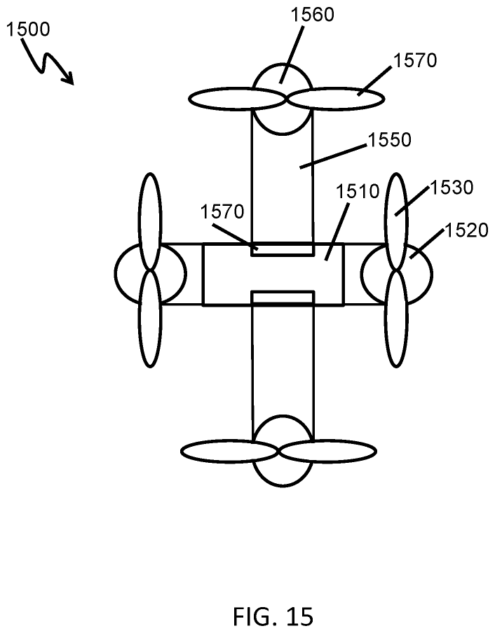

FIG. 15 shows an example of a UAV with one or more arm extensions supporting additional propellers, in accordance with embodiments of the disclosure. The UAV 1500 may comprise a central body 1510. The central body may have any characteristics as described elsewhere herein. The UAV may comprise one or more propulsion units, which may comprise a propeller seat 1520 and/or propeller blades 1530. The propulsion units may have any characteristics as described elsewhere herein.

The UAV may comprise one or more mounting sites 1540. The mounting sites may be provided anywhere on the UAV. The mounting sites may be provided on a central body of the UAV. The mounting sites may be on any surface of the UAV. For example, the mounting sites may be on a top surface of the UAV, bottom surface of the UAV, front surface of the UAV, rear surface of the UAV, right surface of the UAV, and/or a left surface of the UAV. The mounting sites may be oriented vertically or may be oriented horizontally. In some instances, one or more pairs of mounting sites may be provided on opposing sides of the UAV. The mounting sites may have any characteristics as described elsewhere herein.

On or more extensions may be attached to the mounting site. The extensions may be arms 1550 extending away from the mounting site. The arms may comprise one or more propulsion units. For example, each arm may support a propeller seat 1560 and one or more propellers 1570. The propulsion units may be located at or near a distal end of the arms. The propulsion units may be located within 50%, 40%, 30%, 25%, 20%, 10%, 7%, 5%, 3%, 1%, 0.05%, or 0.01% of the distal end of the arm along the length of the arm. The arms may have any length. The arms may have a length less than or equal to a length of the central body. The arms may have a length less than or equal to about half a length of the central body. The arms may have a length greater than a length of the central body or about half a length of the central body.

The arms may be detachably coupled to the central body. The arms may be locked to the central body so that they do not come off during flight of the UAV. A user may manually attach and/or detach the arms from the central body. The arms may not be attached or detached from the central body without manual intervention by the user. The user may attach and/or detach the arms from the body using one or more motions, such as the motions described elsewhere herein. Any number of arms may be attached to the UAV. For instance a single arm, two arms, three arms, four arms, five or arms, six arms, seven arms, eight arms, nine arms, ten arms, or more may be attached to the UAV.

The arms may extend laterally away from the central body. The arms may extend substantially perpendicularly from a surface to which the arms are attached. The arms may extend at oblique angles relative to a surface to which the arms are attached. The arms may extend substantially laterally without tilting upwards or downwards. The arms may extend laterally while tilting upwards and/or downwards. In some instances, when the arms are attached to the mounting sites, the propulsion units supported by the arms may be at the same lateral level as the propulsion units directly supported by the central body. In some instances, the propulsion units supported by the arms may be at a higher lateral level or a lower lateral level compared to the propulsion units directly supported by the central body. The arms may remain substantially static relative to the central body when attached to the central body. Alternatively, the arms may be movable relative to the central body when attached to the central body. For instance, the arms may pivot at the proximal end of the arm that may attach to the body. The arms may pivot through different vertical angles and/or different lateral angles. The arms may have one or more joints that may permit bending or folding of the arms. The arms may move when a user manually manipulates the arms to move in a particular manner. For instance, a user may fold the arms. In some embodiments, the arms may move with aid of one or more actuators. The arms may be capable of moving during flight of the UAV. The arms may be capable of moving during takeoff or landing of the UAV.

The central body may comprise a longitudinal axis extending along a length of the central body. In some instances, the propulsion units supported directly by the central body may be positioned along the longitudinal axis of the central body. The one or more propulsion units supported by the arms may not be located on the longitudinal axis. For instance, the one or more propulsion units supported by the arms may be held off to the sides of the UAV and off the longitudinal axis. In some instances, a pair of arms may be added to the UAV, and allow the UAV to form a quadcopter with the propulsion units supported by the arms and the propulsion units supported directly on the central body.

The UAV may be capable of flight when the arms are not attached to the UAV. The UAV may be capable of flight with aid of the propulsion units directly coupled to the central body. The UAV may be capable of flight with aid of the propulsion units directly supported by the central body alone. The UAV may be capable of flight when the arms are attached to the UAV. The UAV may be capable of flight with aid of propulsion units directly coupled to the central body and propulsion units supported by the arms. The UVA may be capable of flight with aid of propulsion units supported by the arms without requiring the propulsion units supported by the central body.

The mounting site may provide a mechanical and/or electrical connection between the arms and the UAV. The mounting site may physically support the arms on the UAV. The mounting site may allow power and/or data to flow between the arms and the UAV. For instance, the UAV may have a power source which may provide power to the arms via the mounting site connection. For instance, the power source on-board the UAV (e.g., on-board the central body of the UAV) may provide power to the propulsion units supported by the arms. Alternatively or in addition, the arms may have a local power source which may provide power to the UAV, or may provide power to the components on-board the arm. In some instances, the arms may provide information to the UAV when the arms are attached to the UAV. For instance, information about the types of arms and/or propulsion units may be provided to the UAV when the arms are attached to the UAV. Information about operating parameters of the arms may be sent to the UAV. Data used to control the propulsion units may be sent from the UAV to the arms. For instance, a flight controller on-board the UAV may receive information that the arms are attached to the UAV. The flight controller may generate one or more commands to control operation of one or more motors of the propulsion units supported by the arms. The commands may be conveyed through the mounting site to the motors supported by the arms to control operation of the propulsion units.

When the arms are not attached to the UAV, the flight controller may be operating under a first set of instructions to control the propulsion units directly supported by the central body. When the arms are attached to the UAV, the flight controller may be operating under a second set of instructions to control the propulsion units directly supported by the central body and the propulsion units supported by the arm in concert. The UAV may be operating in different modes when the arms are not attached and when the arms are attached.

The UAV and/or components thereof may be provided as a kit. A kit for a UAV may comprise the UAV itself and/or components thereof. The kit for the UAV may comprise the UAV and one or more extensions. The kit for the UAV may comprise one or more extensions, such as protective gear, landing stands, tripods, selfie sticks, handheld slings, arms with propulsion units, or any other type of extensions. The kit for the UAV may comprise instructions for assembly and/or operation of the UAV and/or any components thereof. The kits may comprise instructions for attachment and/or operation of the extensions with the UAV.

The systems and methods described herein can be implemented by and/or applied to a wide variety of movable objects. The systems, devices, and methods described herein can be applied to a wide variety of movable objects. As previously mentioned, any description herein of an aerial vehicle may apply to and be used for any movable object. A movable object of the present disclosure can be configured to move within any suitable environment, such as in air (e.g., a fixed-wing aircraft, a rotary-wing aircraft, or an aircraft having neither fixed wings nor rotary wings), in water (e.g., a ship or a submarine), on ground (e.g., a motor vehicle, such as a car, truck, bus, van, motorcycle; a movable structure or frame such as a stick, fishing pole; or a train), under the ground (e.g., a subway), in space (e.g., a spaceplane, a satellite, or a probe), or any combination of these environments. The movable object can be a vehicle, such as a vehicle described elsewhere herein. In some embodiments, the movable object can be mounted on a living subject, such as a human or an animal. Suitable animals can include primates, avines, canines, felines, equines, bovines, ovines, porcines, delphines, rodents, or insects.

The movable object may be capable of moving freely within the environment with respect to six degrees of freedom (e.g., three degrees of freedom in translation and three degrees of freedom in rotation). Alternatively, the movement of the movable object can be constrained with respect to one or more degrees of freedom, such as by a predetermined path, track, or orientation. The movement can be actuated by any suitable actuation mechanism, such as an engine or a motor. The actuation mechanism of the movable object can be powered by any suitable energy source, such as electrical energy, magnetic energy, solar energy, wind energy, gravitational energy, chemical energy, nuclear energy, or any suitable combination thereof. The movable object may be self-propelled via a propulsion system, as described elsewhere herein. The propulsion system may optionally run on an energy source, such as electrical energy, magnetic energy, solar energy, wind energy, gravitational energy, chemical energy, nuclear energy, or any suitable combination thereof. Alternatively, the movable object may be carried by a living being.

In some instances, the movable object can be a vehicle. Suitable vehicles may include water vehicles, aerial vehicles, space vehicles, or ground vehicles. For example, aerial vehicles may be fixed-wing aircraft (e.g., airplane, gliders), rotary-wing aircraft (e.g., helicopters, rotorcraft), aircraft having both fixed wings and rotary wings, or aircraft having neither (e.g., blimps, hot air balloons). A vehicle can be self-propelled, such as self-propelled through the air, on or in water, in space, or on or under the ground. A self-propelled vehicle can utilize a propulsion system, such as a propulsion system including one or more engines, motors, wheels, axles, magnets, rotors, propellers, blades, nozzles, or any suitable combination thereof. In some instances, the propulsion system can be used to enable the movable object to take off from a surface, land on a surface, maintain its current position and/or orientation (e.g., hover), change orientation, and/or change position.

The movable object can be controlled remotely by a user or controlled locally by an occupant within or on the movable object. In some embodiments, the movable object is an unmanned movable object, such as a UAV. An unmanned movable object, such as a UAV, may not have an occupant onboard the movable object. The movable object can be controlled by a human or an autonomous control system (e.g., a computer control system), or any suitable combination thereof. The movable object can be an autonomous or semi-autonomous robot, such as a robot configured with an artificial intelligence.

The movable object can have any suitable size and/or dimensions. In some embodiments, the movable object may be of a size and/or dimensions to have a human occupant within or on the vehicle. Alternatively, the movable object may be of size and/or dimensions smaller than that capable of having a human occupant within or on the vehicle. The movable object may be of a size and/or dimensions suitable for being lifted or carried by a human. Alternatively, the movable object may be larger than a size and/or dimensions suitable for being lifted or carried by a human. In some instances, the movable object may have a maximum dimension (e.g., length, width, height, diameter, diagonal) of less than or equal to about: 2 cm, 3 cm, 4 cm, 5 cm, 6 cm, 7 cm, 8 cm, 9 cm, 10 cm, 12 cm, 15 cm, 20 cm, 25 cm, 30 cm, 40 cm, 50 cm, 1 m, 2 m, 5 m, or 10 m. The maximum dimension may be greater than or equal to about: 2 cm, 3 cm, 4 cm, 5 cm, 6 cm, 7 cm, 8 cm, 9 cm, 10 cm, 12 cm, 15 cm, 20 cm, 25 cm, 30 cm, 40 cm, 50 cm, 1 m, 2 m, 5 m, or 10 m. For example, the distance between shafts of opposite rotors of the movable object may be less than or equal to about: 1 cm, 2 cm, 3 cm, 4 cm, 5 cm, 6 cm, 7 cm, 8 cm, 9 cm, 10 cm, 12 cm, 15 cm, 20 cm, 25 cm, 30 cm, 40 cm, 50 cm, 1 m, 2 m, 5 m, or 10 m. Alternatively, the distance between shafts of opposite rotors may be greater than or equal to about: 1 cm, 2 cm, 3 cm, 4 cm, 5 cm, 6 cm, 7 cm, 8 cm, 9 cm, 10 cm, 12 cm, 15 cm, 20 cm, 25 cm, 30 cm, 40 cm, 50 cm, 1 m, 2 m, 5 m, or 10 m.

In some embodiments, the movable object may have a volume of less than 100 cm×100 cm×100 cm, less than 50 cm×50 cm×30 cm, or less than 5 cm×5 cm×3 cm. The total volume of the movable object may be less than or equal to about: 1 cm³, 2 cm³, 5 cm³, 10 cm³, 20 cm³, 30 cm³, 40 cm³, 50 cm³, 60 cm³, 70 cm³, 80 cm³, 90 cm³, 100 cm³, 150 cm³, 200 cm³, 300 cm³, 500 cm³, 750 cm³, 1000 cm³, 5000 cm³, 10,000 cm³, 100,000 cm³, 1 m³, or 10 m³.

Conversely, the total volume of the movable object may be greater than or equal to about: 1 cm³, 2 cm³, 5 cm³, 10 cm³, 20 cm³, 30 cm³, 40 cm³, 50 cm³, 60 cm³, 70 cm³, 80 cm³, 90 cm³, 100 cm³, 150 cm³, 200 cm³, 300 cm³, 500 cm³, 750 cm³, 1000 cm³, 5000 cm³, 10,000 cm³, 100,000 cm³, 1 m³, or 10 m³.

In some embodiments, the movable object may have a footprint (which may refer to the lateral cross-sectional area encompassed by the movable object) less than or equal to about: 32,000 cm², 20,000 cm², 10,000 cm², 1,000 cm², 500 cm², 100 cm², 50 cm², 10 cm², or 5 cm². Conversely, the footprint may be greater than or equal to about: 32,000 cm², 20,000 cm², 10,000 cm², 1,000 cm², 500 cm², 100 cm², 50 cm², 10 cm², or 5 cm².

In some instances, the movable object may weigh no more than 1000 kg. The weight of the movable object may be less than or equal to about: 1000 kg, 750 kg, 500 kg, 200 kg, 150 kg, 100 kg, 80 kg, 70 kg, 60 kg, 50 kg, 45 kg, 40 kg, 35 kg, 30 kg, 25 kg, 20 kg, 15 kg, 12 kg, 10 kg, 9 kg, 8 kg, 7 kg, 6 kg, 5 kg, 4 kg, 3 kg, 2 kg, 1 kg, 0.5 kg, 0.1 kg, 0.05 kg, or 0.01 kg. Conversely, the weight may be greater than or equal to about: 1000 kg, 750 kg, 500 kg, 200 kg, 150 kg, 100 kg, 80 kg, 70 kg, 60 kg, 50 kg, 45 kg, 40 kg, 35 kg, 30 kg, 25 kg, 20 kg, 15 kg, 12 kg, 10 kg, 9 kg, 8 kg, 7 kg, 6 kg, 5 kg, 4 kg, 3 kg, 2 kg, 1 kg, 0.5 kg, 0.1 kg, 0.05 kg, or 0.01 kg.

In some embodiments, a movable object may be small relative to a load carried by the movable object. The load may include a payload and/or a carrier, as described in further detail below. In some examples, a ratio of a movable object weight to a load weight may be greater than, less than, or equal to about 1:1. In some instances, a ratio of a movable object weight to a load weight may be greater than, less than, or equal to about 1:1. Optionally, a ratio of a carrier weight to a load weight may be greater than, less than, or equal to about 1:1. When desired, the ratio of an movable object weight to a load weight may be less than or equal to: 1:2, 1:3, 1:4, 1:5, 1:10, or even less. Conversely, the ratio of a movable object weight to a load weight can also be greater than or equal to: 2:1, 3:1, 4:1, 5:1, 10:1, or even greater.

In some embodiments, the movable object may have low energy consumption. For example, the movable object may use less than about: 5 W/h, 4 W/h, 3 W/h, 2 W/h, 1 W/h, or less. In some instances, a carrier of the movable object may have low energy consumption. For example, the carrier may use less than about: 5 W/h, 4 W/h, 3 W/h, 2 W/h, 1 W/h, or less. Optionally, a payload of the movable object may have low energy consumption, such as less than about: 5 W/h, 4 W/h, 3 W/h, 2 W/h, 1 W/h, or less.

In some embodiments, the movable object can be configured to carry a load. The load can include one or more of passengers, cargo, equipment, instruments, and the like. The load can be provided within a housing. The housing may be separate from a housing of the movable object, or be part of a housing for a movable object. Alternatively, the load can be provided with a housing while the movable object does not have a housing. Alternatively, portions of the load or the entire load can be provided without a housing. The load can be rigidly fixed relative to the movable object. Optionally, the load can be movable relative to the movable object (e.g., translatable or rotatable relative to the movable object).

In some embodiments, the load includes a payload. The payload can be configured not to perform any operation or function. Alternatively, the payload can be a payload configured to perform an operation or function, also known as a functional payload. For example, the payload can include one or more sensors for surveying one or more targets. Any suitable sensor can be incorporated into the payload, such as an image capture device (e.g., a camera), an audio capture device (e.g., a parabolic microphone), an infrared imaging device, or an ultraviolet imaging device. The sensor can provide static sensing data (e.g., a photograph) or dynamic sensing data (e.g., a video). In some embodiments, the sensor provides sensing data for the target of the payload. Alternatively or in combination, the payload can include one or more emitters for providing signals to one or more targets. Any suitable emitter can be used, such as an illumination source or a sound source. In some embodiments, the payload includes one or more transceivers, such as for communication with a module remote from the movable object. Optionally, the payload can be configured to interact with the environment or a target. For example, the payload can include a tool, instrument, or mechanism capable of manipulating objects, such as a robotic arm.

Optionally, the load may include a carrier. The carrier can be provided for the payload and the payload can be coupled to the movable object via the carrier, either directly (e.g., directly contacting the movable object) or indirectly (e.g., not contacting the movable object). Conversely, the payload can be mounted on the movable object without requiring a carrier. The payload can be integrally formed with the carrier. Alternatively, the payload can be releasably coupled to the carrier. In some embodiments, the payload can include one or more payload elements, and one or more of the payload elements can be movable relative to the movable object and/or the carrier, as described above.

The carrier can be integrally formed with the movable object. Alternatively, the carrier can be releasably coupled to the movable object. The carrier can be coupled to the movable object directly or indirectly. The carrier can provide support to the payload (e.g., carry at least part of the weight of the payload). The carrier can include a suitable mounting structure (e.g., a gimbal platform) capable of stabilizing and/or directing the movement of the payload. In some embodiments, the carrier can be adapted to control the state of the payload (e.g., position and/or orientation) relative to the movable object. For example, the carrier can be configured to move relative to the movable object (e.g., with respect to one, two, or three degrees of translation and/or one, two, or three degrees of rotation) such that the payload maintains its position and/or orientation relative to a suitable reference frame regardless of the movement of the movable object. The reference frame can be a fixed reference frame (e.g., the surrounding environment). Alternatively, the reference frame can be a moving reference frame (e.g., the movable object, a payload target).

In some embodiments, the carrier can be configured to permit movement of the payload relative to the carrier and/or movable object. The movement can be a translation with respect to up to three degrees of freedom (e.g., along one, two, or three axes) or a rotation with respect to up to three degrees of freedom (e.g., about one, two, or three axes), or any suitable combination thereof.

In some instances, the carrier can include a carrier frame assembly and a carrier actuation assembly. The carrier frame assembly can provide structural support to the payload. The carrier frame assembly can include individual carrier frame components, some of which can be movable relative to one another. The carrier actuation assembly can include one or more actuators (e.g., motors) that actuate movement of the individual carrier frame components. The actuators can permit the movement of multiple carrier frame components simultaneously, or may be configured to permit the movement of a single carrier frame component at a time. The movement of the carrier frame components can produce a corresponding movement of the payload. For example, the carrier actuation assembly can actuate a rotation of one or more carrier frame components about one or more axes of rotation (e.g., roll axis, pitch axis, or yaw axis). The rotation of the one or more carrier frame components can cause a payload to rotate about one or more axes of rotation relative to the movable object. Alternatively or in combination, the carrier actuation assembly can actuate a translation of one or more carrier frame components along one or more axes of translation, and thereby produce a translation of the payload along one or more corresponding axes relative to the movable object.

In some embodiments, the movement of the movable object, carrier, and payload relative to a fixed reference frame (e.g., the surrounding environment) and/or to each other, can be controlled by a terminal. The terminal can be a remote control device at a location distant from the movable object, carrier, and/or payload. The terminal can be disposed on or affixed to a support platform. Alternatively, the terminal can be a handheld or wearable device. For example, the terminal can include a smartphone, tablet, laptop, computer, glasses, gloves, helmet, microphone, or suitable combinations thereof. The terminal can include a user interface, such as a keyboard, mouse, joystick, touchscreen, or display. Any suitable user input can be used to interact with the terminal, such as manually entered commands, voice control, gesture control, or position control (e.g., via a movement, location or tilt of the terminal). The terminal can be the same remote controller as described previously herein.

The terminal can be used to control any suitable state of the movable object, carrier, and/or payload. For example, the terminal can be used to control the position and/or orientation of the movable object, carrier, and/or payload relative to a fixed reference from and/or to each other. In some embodiments, the terminal can be used to control individual elements of the movable object, carrier, and/or payload, such as the actuation assembly of the carrier, a sensor of the payload, or an emitter of the payload. The terminal can include a wireless communication device adapted to communicate with one or more of the movable object, carrier, or payload.

The terminal can include a suitable display unit for viewing information of the movable object, carrier, and/or payload. For example, the terminal can be configured to display information of the movable object, carrier, and/or payload with respect to position, translational velocity, translational acceleration, orientation, angular velocity, angular acceleration, or any suitable combinations thereof. In some embodiments, the terminal can display information provided by the payload, such as data provided by a functional payload (e.g., images recorded by a camera or other image capturing device).

Optionally, the same terminal may both control the movable object, carrier, and/or payload, or a state of the movable object, carrier and/or payload, as well as receive and/or display information from the movable object, carrier and/or payload. For example, a terminal may control the position of the payload relative to an environment, while displaying image data captured by the payload, or information about the position of the payload. Alternatively, different terminals may be used for different functions. For example, a first terminal may control movement or a state of the movable object, carrier, and/or payload while a second terminal may receive and/or display information from the movable object, carrier, and/or payload. For example, a first terminal may be used to control the positioning of the payload relative to an environment while a second terminal displays image data captured by the payload. Various communication modes may be utilized between a movable object and an integrated terminal that both controls the movable object and receives data, or between the movable object and multiple terminals that both control the movable object and receives data. For example, at least two different communication modes may be formed between the movable object and the terminal that both controls the movable object and receives data from the movable object.

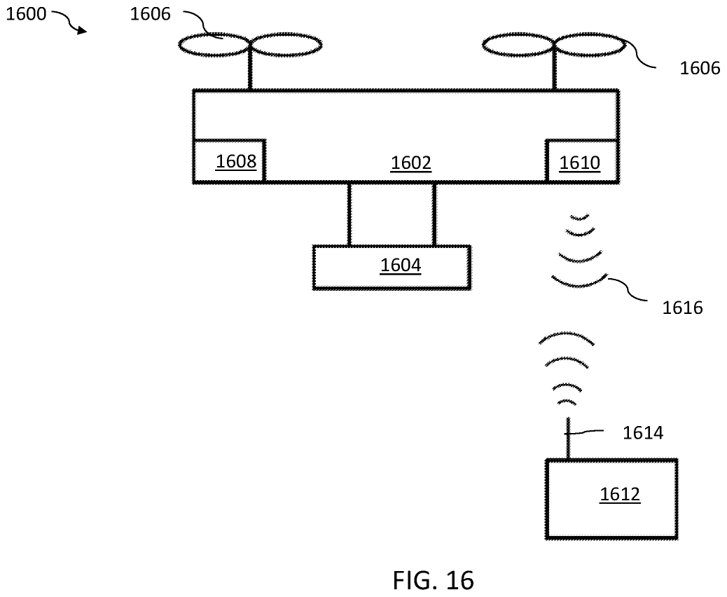

In some embodiments, the movable object that supports the imaging device may be a UAV. FIG. 16 illustrates a movable object 1600 including a carrier 1602 and a payload 1604, in accordance with embodiments. Although the movable object 1600 is depicted as an aircraft, this depiction is not intended to be limiting, and any suitable type of movable object can be used, as previously described herein. One of skill in the art would appreciate that any of the embodiments described herein in the context of aircraft systems can be applied to any suitable movable object (e.g., a UAV). In some instances, the payload 1604 may be provided on the movable object 1600 without requiring the carrier 1602. The payload may include one or more imaging devices. The movable object 1600 may include propulsion mechanisms 1606, a sensing system 1608, and a communication system 1610.

Furthermore, while a payload and a single carrier may be illustrated herein, any number of carriers and/or payloads may be carried by a UAV. For instance, the UAV may bear the weight of two or more, three or more, four or more, or five or more carriers (e.g., gimbals), each supporting one or more payloads (e.g., cameras). For example, a dual-camera configuration may be provided as described elsewhere herein.

The propulsion mechanisms 1606 can include one or more of rotors, propellers, blades, engines, motors, wheels, axles, magnets, or nozzles, as previously described. For example, the propulsion mechanisms 1606 may be self-tightening rotors, rotor assemblies, or other rotary propulsion units, as disclosed elsewhere herein. The movable object may have one or more, two or more, three or more, or four or more propulsion mechanisms. The propulsion mechanisms may all be of the same type. Alternatively, one or more propulsion mechanisms can be different types of propulsion mechanisms. The propulsion mechanisms 1606 can be mounted on the movable object 1600 using any suitable means, such as a support element (e.g., a drive shaft) as described elsewhere herein. The propulsion mechanisms 1606 can be mounted on any suitable portion of the movable object 1600, such on the top, bottom, front, back, sides, or suitable combinations thereof.

In some embodiments, the propulsion mechanisms 1606 can enable the movable object 1600 to take off vertically from a surface or land vertically on a surface without requiring any horizontal movement of the movable object 1600 (e.g., without traveling down a runway). Optionally, the propulsion mechanisms 1606 can be operable to permit the movable object 1600 to hover in the air at a specified position and/or orientation. One or more of the propulsion mechanism 1600 may be controlled independently of the other propulsion mechanisms. Alternatively, the propulsion mechanisms 1600 can be configured to be controlled simultaneously. For example, the movable object 1600 can have multiple horizontally oriented rotors that can provide lift and/or thrust to the movable object. The multiple horizontally oriented rotors can be actuated to provide vertical takeoff, vertical landing, and hovering capabilities to the movable object 1600. In some embodiments, one or more of the horizontally oriented rotors may spin in a clockwise direction, while one or more of the horizontally rotors may spin in a counterclockwise direction. For example, the number of clockwise rotors may be equal to the number of counterclockwise rotors. The rotation rate of each of the horizontally oriented rotors can be varied independently in order to control the lift and/or thrust produced by each rotor, and thereby adjust the spatial disposition, velocity, and/or acceleration of the movable object 1600 (e.g., with respect to up to three degrees of translation and up to three degrees of rotation).

The sensing system 1608 can include one or more sensors that may sense the spatial disposition, velocity, and/or acceleration of the movable object 1600 (e.g., with respect to up to three degrees of translation and up to three degrees of rotation). The one or more sensors can include any of the sensors previously described herein, including GPS sensors, motion sensors, inertial sensors, proximity sensors, or image sensors. The sensing data provided by the sensing system 1608 can be used to control the spatial disposition, velocity, and/or orientation of the movable object 1600 (e.g., using a suitable processing unit and/or control module, as described below). Alternatively, the sensing system 1608 can be used to provide data regarding the environment surrounding the movable object, such as weather conditions, proximity to potential obstacles, location of geographical features, location of manmade structures, and the like.

The communication system 1610 enables communication with terminal 1612 having a communication system 1614 via wireless signals 1616. The communication systems 1610, 1614 may include any number of transmitters, receivers, and/or transceivers suitable for wireless communication. The communication may be one-way communication, such that data can be transmitted in only one direction. For example, one-way communication may involve only the movable object 1600 transmitting data to the terminal 1612, or vice-versa. The data may be transmitted from one or more transmitters of the communication system 1610 to one or more receivers of the communication system 1612, or vice-versa. Alternatively, the communication may be two-way communication, such that data can be transmitted in both directions between the movable object 1600 and the terminal 1612. The two-way communication can involve transmitting data from one or more transmitters of the communication system 1610 to one or more receivers of the communication system 1614, and vice-versa.

In some embodiments, the terminal 1612 can provide control data to one or more of the movable object 1600, carrier 1602, and payload 1604 and receive information from one or more of the movable object 1600, carrier 1602, and payload 1604 (e.g., position and/or motion information of the movable object, carrier or payload; data sensed by the payload such as image data captured by a payload camera). The terminal can be the same as the remote controller as described previously. In some instances, control data from the terminal may include instructions for relative positions, movements, actuations, or controls of the movable object, carrier, and/or payload. For example, the control data may result in a modification of the location and/or orientation of the movable object (e.g., via control of the propulsion mechanisms 1606), or a movement of the payload with respect to the movable object (e.g., via control of the carrier 1602). The control data from the terminal may result in control of the payload, such as control of the operation of a camera or other image capturing device (e.g., taking still or moving pictures, zooming in or out, turning on or off, switching imaging modes, change image resolution, changing focus, changing depth of field, changing exposure time, changing viewing angle or field of view). In some instances, the communications from the movable object, carrier and/or payload may include information from one or more sensors (e.g., of the sensing system 1608 or of the payload 1604). The communications may include sensed information from one or more different types of sensors (e.g., GPS sensors, motion sensors, inertial sensor, proximity sensors, or image sensors). Such information may pertain to the position (e.g., location, orientation), movement, or acceleration of the movable object, carrier, and/or payload. Such information from a payload may include data captured by the payload or a sensed state of the payload. The control data provided transmitted by the terminal 1612 can be configured to control a state of one or more of the movable object 1600, carrier 1602, or payload 1604. Alternatively or in combination, the carrier 1602 and payload 1604 can also each include a communication module configured to communicate with terminal 1612, such that the terminal can communicate with and control each of the movable object 1600, carrier 1602, and payload 1604 independently.

In some embodiments, the movable object 1600 can be configured to communicate with another remote device in addition to the terminal 1612, or instead of the terminal 1612. The terminal 1612 may also be configured to communicate with another remote device as well as the movable object 1600. For example, the movable object 1600 and/or terminal 1612 may communicate with another movable object, or a carrier or payload of another movable object. When desired, the remote device may be a second terminal or other computing device (e.g., computer, laptop, tablet, smartphone, or other mobile device). The remote device can be configured to transmit data to the movable object 1600, receive data from the movable object 1600, transmit data to the terminal 1612, and/or receive data from the terminal 1612. Optionally, the remote device can be connected to the Internet or other telecommunications network, such that data received from the movable object 1600 and/or terminal 1612 can be uploaded to a website or server.

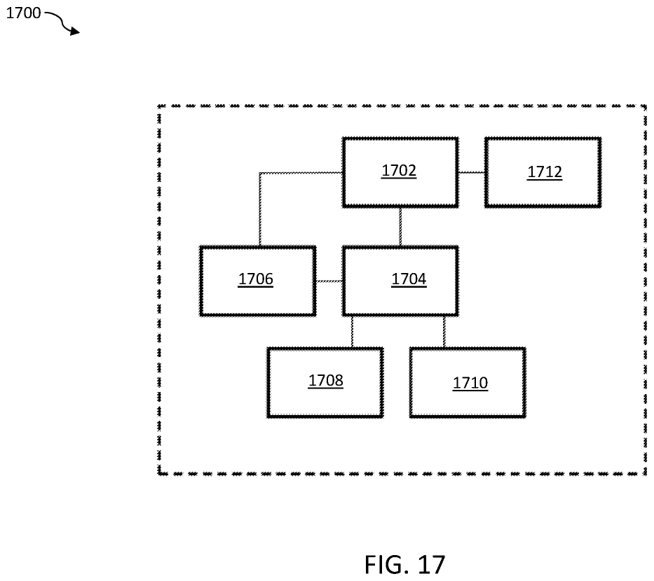

FIG. 17 illustrates an exemplary system 1700 for capturing image data, in accordance with embodiments. The system 1700 can be used in combination with any suitable embodiment of the systems, devices, and methods disclosed herein. For example, the system 1700 may implemented or carried by a movable object. The system 1700 can include a sensing module 1702, processing unit 1704, non-transitory computer readable medium 1706, control module 1708, and communication module 1710.

The sensing module 1702 can utilize different types of sensors that collect information relating to the movable objects in different ways. Different types of sensors may sense different types of signals or signals from different sources. For example, the sensors can include inertial sensors, GPS sensors, proximity sensors (e.g., lidar), or vision/image sensors (e.g., a camera). The sensing module 1702 can be operatively coupled to a processing unit 1704 having a plurality of processors. In some embodiments, the sensing module can be operatively coupled to a transmission module 1712 (e.g., a Wi-Fi image transmission module) configured to directly transmit sensing data to a suitable external device or system. For example, the transmission module 1712 can be used to transmit images captured by one or more cameras of the sensing module 1702 to a remote terminal. For instance, the transmission module may be used to transmit images captured by multiple cameras supported by multiple gimbals to a remote terminal.

The processing unit 1704 can have one or more processors, such as a programmable processor (e.g., a central processing unit (CPU)). For example, the processing unit 1704 may include a field programmable gate array (FPGA) and/or one or more ARM processors. The processing unit 1704 can be operatively coupled to a non-transitory computer readable medium 1706. The non-transitory computer readable medium 1706 can store logic, code, and/or program instructions executable by the processing unit 1704 for performing one or more steps. The non-transitory computer readable medium can include one or more memory units (e.g., removable media or external storage such as an SD card or random access memory (RAM)). In some embodiments, data from the sensing module 1702 can be directly conveyed to and stored within the memory units of the non-transitory computer readable medium 1706. The memory units of the non-transitory computer readable medium 1706 can store logic, code and/or program instructions executable by the processing unit 1704 to perform any suitable embodiment of the methods described herein. For example, the processing unit 1704 can be configured to execute instructions causing one or more processors of the processing unit 1704 to perform the image zoom control functionalities discussed herein. The memory units can store sensing data from the sensing module to be processed by the processing unit 1704. In some embodiments, the memory units of the non-transitory computer readable medium 1706 can be used to store the processing results produced by the processing unit 1704.

In some embodiments, the processing unit 1704 can be operatively coupled to a control module 1708 configured to control a state of the movable object. For example, the control module 1708 can be configured to control the propulsion mechanisms of the movable object to adjust the spatial disposition, velocity, and/or acceleration of the movable object with respect to six degrees of freedom. Alternatively or in combination, the control module 1708 can control one or more of a state of a carrier, payload, or sensing module.

The processing unit 1704 can be operatively coupled to a communication module 1710 configured to transmit and/or receive data from one or more external devices (e.g., a terminal, display device, or other remote controller). Any suitable means of communication can be used, such as wired communication or wireless communication. For example, the communication module 1710 can utilize one or more of local area networks (LAN), wide area networks (WAN), infrared, radio, WiFi, point-to-point (P2P) networks, telecommunication networks, cloud communication, and the like. Optionally, relay stations, such as towers, satellites, or mobile stations, can be used. Wireless communications can be proximity dependent or proximity independent. In some embodiments, line-of-sight may or may not be required for communications. The communication module 1710 can transmit and/or receive one or more of sensing data from the sensing module 1702, and/or processing results produced by the processing unit 1704, predetermined control data or user commands from a terminal or remote controller, and the like.

The components of the system 1700 can be arranged in any suitable configuration. For example, one or more of the components of the system 1700 can be located on the movable object, carrier, payload, terminal, sensing system, or an additional external device in communication with one or more of the above. Additionally, although FIG. 17 depicts a single processing unit 1704 and a single non-transitory computer readable medium 1706, one of skill in the art would appreciate that this is not intended to be limiting, and that the system 1700 can include a plurality of processing units and/or non-transitory computer readable media. In some embodiments, one or more of the plurality of processing units and/or non-transitory computer readable media can be situated at different locations, such as on the movable object, carrier, payload, terminal, sensing module, additional external device in communication with one or more of the above, or suitable combinations thereof, such that any suitable aspect of the processing and/or memory functions performed by the system 1700 can occur at one or more of the aforementioned locations.

It should be understood from the foregoing that, while particular implementations have been illustrated and described, various modifications can be made thereto and are contemplated herein. It is also not intended that the disclosure be limited by the specific examples provided within the specification. While the disclosure has been described with reference to the aforementioned specification, the descriptions and illustrations of the embodiments herein are not meant to be construed in a limiting sense. Furthermore, it shall be understood that all aspects of the disclosure are not limited to the specific depictions, configurations or relative proportions set forth herein which depend upon a variety of conditions and variables. Various modifications in form and detail of the embodiments of the disclosure will be apparent to a person skilled in the art. It is therefore contemplated that the disclosure shall also cover any such modifications, variations and equivalents.

What is claimed is:

1. An unmanned aerial vehicle (UAV) comprising:
a central body having a lateral dimension substantially less than a vertical dimension; and
one or more propulsion units supported by the central body, wherein the one or more propulsion units comprise rotor blades configured to rotate to generate lift for the UAV.

2. The UAV of claim 1, wherein the lateral dimension is a width w of the central body and the vertical dimension is a height h of the central body, and the ratio of h:w is greater than or equal to 2:1.

3. The UAV of claim 2, wherein the central body also has a length 1 of the central body, and the ratio of l:w is greater than or equal to 2:1.

4. The UAV of claim 2, wherein the width of the central body is sized to be small enough to reduce obstruction of downward airflow generated by the rotor blades.

5. The UAV of claim 1, wherein the lateral dimension is less than 3 cm.

6. The UAV of claim 1, further comprising an image capture device supported by the central body, wherein the central body has a portable and ergonomic shape to permit handheld imaging.

7. The UAV of claim 6, wherein the image capture device is supported by the central body with aid of a carrier that permits the image capture device to rotate about one or more axes relative to the central body.

8. The UAV of claim 1, wherein the lateral dimension is sized to be small enough to permit the UAV to land or take off from a user's hand while allowing a user's hand to grasp opposing sides of the central body.

9. The UAV of claim 1, wherein the vertical dimension is sized to be great enough to allow the UAV to land or take off from a user's hand without the user's hand coming into contact with the rotor blades when the user's hand grasps opposing sides of the central body.

10. The UAV of claim 1, wherein the central body is shaped to provide less than a predetermined threshold of air resistance in a direction of flight.

11. The UAV of claim 1, wherein the one or more propulsion units are directly supported on the central body without the use of arms extending away from the central body.

12. A method for providing an unmanned aerial vehicle (UAV), comprising:
providing a central body having a lateral dimension substantially less than a vertical dimension; and
supporting, by the central body, one or more propulsion units, wherein the one or more propulsion units comprise rotor blades configured to rotate to generate lift for the UAV.

13. The method of claim 12, wherein the lateral dimension is a width w of the central body and the vertical dimension is a height h of the central body, and the ratio of h:w is greater than or equal to 2:1.

14. The method of claim 13, wherein the width of the central body is sized to be small enough to reduce obstruction of downward airflow generated by the rotor blades.

15. The method of claim 12, further comprising providing an image capture device supported by the central body, wherein the central body has a portable and ergonomic shape to permit handheld imaging.

16. The method of claim 15, wherein the image capture device is supported by the central body with aid of a carrier that permits the image capture device to rotate about one or more axes relative to the central body.

17. The method of claim 12, wherein the lateral dimension is sized to be small enough to permit the UAV to land or take off from a user's hand while allowing a user's hand to grasp opposing sides of the central body.

18. The method of claim 12, wherein the vertical dimension is sized to be great enough to allow the UAV to land or take off from a user's hand without the user's hand coming into contact with the rotor blades when the user's hand grasps opposing sides of the central body.

19. The method of claim 12, wherein the central body is shaped to provide less than a predetermined threshold of air resistance in a direction of flight.

20. The method of claim 12, wherein the one or more propulsion units are directly supported on the central body without the use of arms extending away from the central body.
